(19) United States
(12) Patent Application Publication
(10) Pub. No.: US 2025/0258871 A1
(43) Pub. Date: Aug. 14, 2025

(54) Systems and Methods for Updating a Validation Sample

(71) Applicant: RELATIVITY ODA LLC, Chicago, IL (US)

(72) Inventors: Aron Ahmadia, Arlington, VA (US); Miguel Martinez, Chicago, IL (US); Elise Tropiano, Evanston, IL (US); Evan Curtin, Brooklyn, NY (US); Nathan Reff, Rochester, NY (US)

(21) Appl. No.: 19/052,200

(22) Filed: Feb. 12, 2025

Related U.S. Application Data
(60) Provisional application No. 63/757,288, filed on Feb. 11, 2025.
(60) Provisional application No. 63/748,251, filed on Jan. 22, 2025.
(60) Provisional application No. 63/702,637, filed on Oct. 2, 2024.
(60) Provisional application No. 63/559,660, filed on Feb. 29, 2024.
(60) Provisional application No. 63/552,278, filed on Feb. 12, 2024.

(51) Int. Cl. G06F 16/906; G06F 16/93

(52) U.S. Cl. CPC G06F 16/906; G06F 16/93

(57) ABSTRACT

The following relates generally to using generative AI to: (i) classify documents; (ii) generate prompts (and/or criteria for prompts) to classify documents; (iii) explain document classifications; and/or (iv) explain updates to prompts (and/or prompt criteria). In some embodiments, one or more processors: obtain an initial set of documents from a corpus of documents; classify documents within the initial set of documents by inputting a prompt and the documents within the initial set of documents into a generative artificial intelligence (AI) model; and evaluate classification performance of the prompt to identify (i) that the initial set of documents does not include enough documents associated with a first issue of the one or more issues, or (ii) that the corpus of documents is associated with a new issue.

### CROSS REFERENCE TO RELATED APPLICATIONS

This application claims priority to and the benefit of the filing date of (1) U.S. Provisional Application No. 63/552,278, entitled “Scalable Prompt Engineering for LLMs with Testing and Merging” (filed Feb. 12, 2024), (2) U.S. Provisional Application No. 63/559,660, entitled “Scalable Prompt Engineering for LLMs with Testing and Merging” (filed Feb. 29, 2024), (3) U.S. Provisional Application No. 63/702,637, entitled “Scalable Prompt Engineering with Testing and Merging” (filed Oct. 2, 2024), (4) U.S. Provisional Application No. 63/748,251, entitled “Scalable Prompt Engineering with Testing and Merging” (filed Jan. 22, 2025), (5) U.S. Provisional Application No. 63/757,288, entitled “Scalable Prompt Engineering with Testing and Merging” (filed Feb. 11, 2025), the entire contents of each of which is hereby expressly incorporated herein by reference.

### FIELD

The present disclosure generally relates to generative artificial intelligence (AI), and more particularly relates to using generative AI to, among other things: (i) classify documents; (ii) generate prompts (and/or criteria for prompts) to classify documents; (iii) explain document classifications; and/or (iv) explain updates to prompts (and/or prompt criteria).

### BACKGROUND

In the eDiscovery process commonly associated with litigation, for example, reviewers (e.g., attorneys) are commonly provided with a voluminous corpus of documents (e.g., emails, SMS communications, group texts, presentations, reports, spreadsheets, etc.) that conform to a discovery request. Thus, rather than manually review each document in the corpus, eDiscovery processes sometimes deploy machine learning models to identify documents responsive to an inquiry (e.g., identifying privileged documents, documents responsive to a discovery request, etc.).

However, in some instances, even deploying machine learning models may be cumbersome and inefficient. For example, different attorneys working on the same case may have different ideas about which documents should be indicated as responsive; and thus the attorneys may deploy the machine learning models in different ways, resulting in conflicting indications of responsiveness. As another example, training a machine learning classifier may require manual review of thousands of documents to generate a sufficient number of labeled training examples for the classifier to satisfy performance requirements.

The systems and methods disclosed herein provide solutions to these problems and may provide solutions to the ineffectiveness, insecurities, difficulties, inefficiencies, encumbrances, and/or other drawbacks of conventional techniques.

### SUMMARY

In one aspect, a computer-implemented method for using a generative artificial intelligence (AI) model to classify documents may be provided. In one example, the method may include: (1) obtaining, via one or more processors, an initial set of documents from a corpus of documents; (2) obtaining, via the one or more processors, prompt criteria defining an inquiry associated with the corpus of documents, wherein the prompt criteria define one or more issues associated with the corpus of documents; (3) generating, via the one or more processors, a prompt based on the prompt criteria; (4) classifying, via the one or more processors, documents within the initial set of documents by inputting the prompt and the documents within the initial set of documents into the generative AI model; (5) evaluating, via the one or more processors, classification performance of the prompt to identify (i) that the initial set of documents does not include enough documents associated with a first issue of the one or more issues, or (ii) that the corpus of documents is associated with a new issue; (6) generating, via the one or more processors, a request for documents from the corpus of documents based on the first issue or the new issue; (7) obtaining, via the one or more processors, documents responsive to the request for documents; and (8) adding, via the one or more processors, the obtained documents to the initial set of documents.

In another aspect, a computer system for classifying documents may be provided. The one or more non-transitory memories having stored thereon computer-executable instructions that, when executed by the one or more processors, may cause the one or more processors to: (1) obtain an initial set of documents from a corpus of documents; (2) obtain prompt criteria defining an inquiry associated with the corpus of documents, wherein the prompt criteria define one or more issues associated with the corpus of documents; (3) generate a prompt based on the prompt criteria; (4) classify documents within the initial set of documents by inputting the prompt and the documents within the initial set of documents into the generative AI model; (5) evaluate classification performance of the prompt to identify (i) that the initial set of documents does not include enough documents associated with a first issue of the one or more issues, or (ii) that the corpus of documents is associated with a new issue; (6) generate a request for documents from the corpus of documents based on the first issue or the new issue; (7) obtain documents responsive to the request for documents; and (8) add the obtained documents to the initial set of documents.

In yet another aspect, a tangible, non-transitory computer readable medium storing computer-readable instructions for classifying documents may be provided. In one example, the tangible, non-transitory computer readable medium, when executed by one or more processors of a computer system, may cause the computer system to: (1) obtain an initial set of documents from a corpus of documents; (2) obtain prompt criteria defining an inquiry associated with the corpus of documents, wherein the prompt criteria define one or more issues associated with the corpus of documents; (3) generate a prompt based on the prompt criteria; (4) classify documents within the initial set of documents by inputting the prompt and the documents within the initial set of documents into the generative AI model; (5) evaluate classification performance of the prompt to identify (i) that the initial set of documents does not include enough documents associated with a first issue of the one or more issues, or (ii) that the corpus of documents is associated with a new issue; (6) generate a request for documents from the corpus of documents based on the first issue or the new issue; (7) obtain documents responsive to the request for documents; and (8) add the obtained documents to the initial set of documents.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an example computer environment for using a generative AI model to: (i) classify documents, and/or (ii) provide explanations in which the exemplary computer-implemented methods described herein may be implemented.

FIG. 2 illustrates an example screen allowing a user to enter criteria including setup criteria.

FIG. 3 illustrates an example screen allowing a user to enter criteria including case summary criteria.

FIG. 4 illustrates an example screen allowing a user to enter criteria including relevance criteria.

FIG. 5 illustrates an example screen allowing a user to enter criteria including key documents criteria.

FIG. 6 illustrates an example computer-implemented method of using a generative AI model to: (i) classify documents, and/or (ii) provide explanations.

FIG. 7 illustrates an example screen including example classifications of documents, and example explanations thereof.

FIG. 8 illustrates an example screen including a document classification and a document comment.

FIG. 9 illustrates an example implantation of merging document comments.

FIG. 10 illustrates an example computing system, according to an embodiment.

FIG. 11 illustrates an example combined block and logic diagram for iterative prompting of an example generative AI model.

FIG. 12 illustrates an example computer-implemented method for using a generative artificial intelligence (AI) model to classify documents.

FIG. 13 illustrates an example combined block and logic diagram for automated prompting of an example generative AI model.

FIG. 14 illustrates an example computer-implemented method for using a generative artificial intelligence (AI) model to classify documents.

FIG. 15 illustrates an example combined block and logic diagram for automated prompting of an example generative AI model.

FIG. 16 illustrates an example computer-implemented method for using a generative artificial intelligence (AI) model to classify documents.

FIG. 17 illustrates an example combined block and logic diagram for document sampling and prompt generation.

FIG. 18 illustrates an example computer-implemented method for using a generative artificial intelligence (AI) model to classify documents.

FIG. 19 illustrates an example combined block and logic diagram for training a classifier using an example generative AI model.

FIG. 20 illustrates an example computer-implemented method for using a generative artificial intelligence (AI) model to train a classifier.

### DETAILED DESCRIPTION

The present techniques relate to generative artificial intelligence (AI), and more particularly relate to using generative AI to: (i) classify documents; (ii) generate prompts (and/or criteria for prompts) to classify documents; (iii) explain document classifications; and/or (iv) explain updates to prompts (and/or prompt criteria).

In some embodiments, these techniques are applied in the eDiscovery process. For example, in the eDiscovery process, reviewers (e.g., attorneys, etc.) are commonly provided with a voluminous corpus of documents (e.g., emails, SMS communications, group texts, presentations, reports, spreadsheets, etc.) that conform to a discovery request. Thus, rather than manually review each document in the corpus, eDiscovery processes commonly deploy machine learning models to identify documents responsive to an inquiry (e.g., identifying privileged documents, documents responsive to a discovery request, etc.). However, these machine learning processes involve a significant number of manually-labeled training examples before a classifier can be sufficiently trained to have statistical confidence in its performance with respect to remaining documents in the corpus. Thus, some conventional machine learning-based process involve a significant amount of manual review time before the machine learning classifiers can be deployed.

On the other hand, techniques described herein related to generating a prompt-based classification model that is used in conjunction with a generative AI model such that the generative AI model is able to accurately classify the documents. Said another way, techniques described herein relate to modifying a prompt that includes classification instructions for how a generative AI model is to classify a document, rather than training a machine learning classifier. As one example, the prompt-based model may include one more categories and/or criteria that indicate to the generative AI model how documents should be classified. For instance, one criterion may indicate that any emails mentioning the chief executive officer (CEO) of a company should be classified as responsive. Other examples will be described in more detail below. It should be appreciated that while the process of refining the prompt-based model described herein still involves manual review of outputs from the generative AI model, the amount of review is significantly less than required to train a conventional machine learning classifier.

As will be explained herein, there are unique challenges to overcome to efficiently implement a prompt-based classification model. As one example, different attorneys working on the same case may have different ideas about which documents should be indicated as responsive; and thus the attorneys may input different criteria to generate the prompt, resulting in conflicting classifications of responsiveness. As another example, a first reviewer may review documents with respect to a first inquiry included in the prompt-based classification model. In this example, consolidating the feedback with respect to the first inquiry into the corresponding portion of the prompt-based classification model may still impact the performance of the model with respect to a second inquiry included in the prompt-based classification model. As another example, in some embodiments, a generative AI model may assist in updating the prompt (e.g., by reconciling different comments from different users). Accordingly, it may not always be clear why a document was classified in a particular way.

The systems and methods disclosed herein provide solutions to these problems and others.

### Example Environment

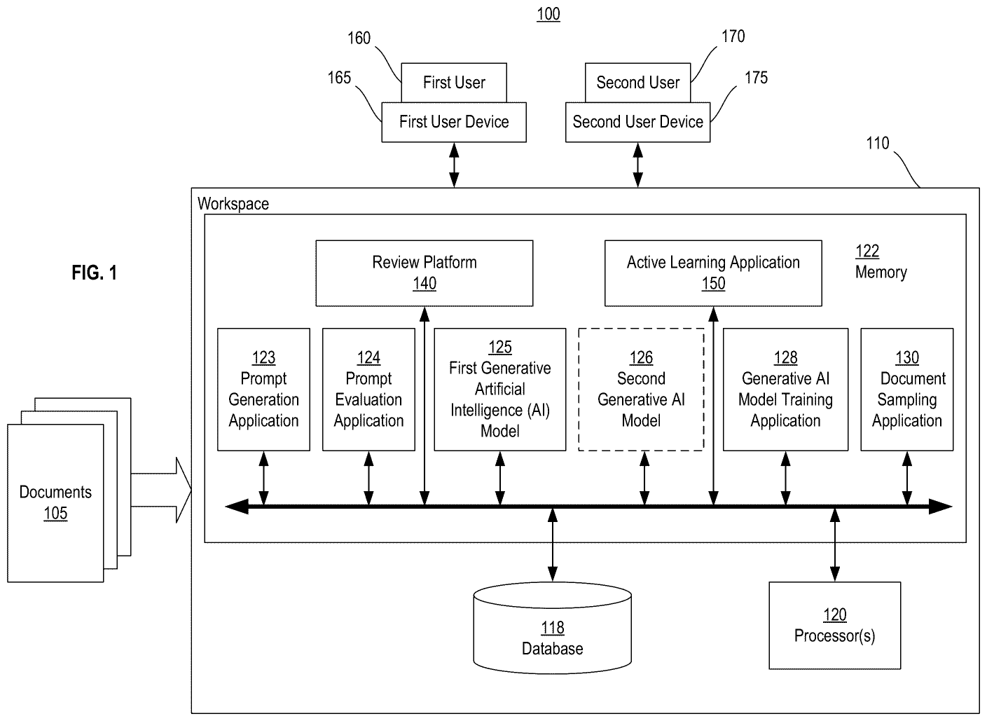

To this end, FIG. 1 illustrates an exemplary computer environment 100 for using a generative AI model to: (i) classify documents, and/or (ii) provide explanations in which the exemplary computer-implemented methods described herein may be implemented. The high-level architecture includes both hardware and software applications, as well as various data communications channels for communicating data between the various hardware and software components.

As illustrated, the computing environment 100 includes a workspace 110 associated with a corpus of documents 105, such as a set of documents associated with an eDiscovery project. Such documents in the corpus of documents 105 may have file types. Examples of the file type include: an email file, a word processing file, a spreadsheet file, an audio recording, imagery data (e.g., image and/or video data), a text message, etc.

The workspace 110 and/or the components thereof may be implemented as software modules within a cloud and/or distributed computing system (e.g., Amazon Web Services (AWS) or Microsoft Azure). Accordingly, the components of the workspace 110 may include separate logical addresses via which the components are accessible via a bus 115 or other messaging channel supported by the cloud computing system. In some embodiments, the workspace 110 includes multiple instances of the same component to increase the ability the parallelization for the various functions performed via the respective components.

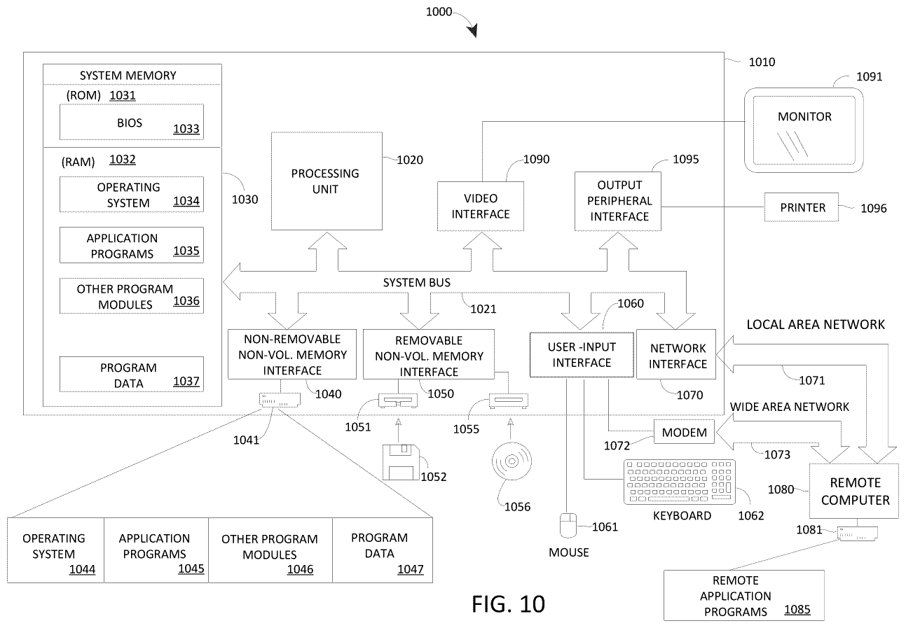

To implement the computing environment 100, a computing system may be used, such as computing system 1000 of the example of FIG. 10 to host and/or execute at least a portion of the workspace 110. The computing system 1000 may include a computer 1010. Components of the computer 1010 may include, but are not limited to, a processing unit 1020, a system memory 1030, and a system bus 1021 that couples various system components including the system memory 1030 to the processing unit 1020. In some embodiments, the processing unit 1020 may include one or more parallel processing units capable of processing data in parallel with one another. The system bus 1021 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 1010 may include a variety of computer-readable media. Computer-readable media may be any available media that can be accessed by computer 1010 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 1030 may include computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to, and/or presently being operated on, by processing unit 1020. By way of example, and not limitation, FIG. 10 illustrates operating system 1034, application programs 1035, other program modules 1036, and program data 1037. For example, the application programs 1035, the program modules 1036 and/or the program 1037 may include any of the applications executed within the workspace 110.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 may be connected to the system bus 1021 through a non-removable memory interface such as interface 1040, and magnetic disk drive 1051 and optical disk drive 1055 may be connected to the system bus 1021 by a removable memory interface, such as interface 1050.

The drives and their associated computer storage media discussed above and illustrated in FIG. 10 provide storage of computer-readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information into the computer 1010 through input devices such as cursor control device 1061 (e.g., a mouse, trackball, touch pad, etc.) and keyboard 1062. A monitor 1091 or other type of display device is also connected to the system bus 1021 via an interface, such as a video interface 1090. In addition to the monitor, computers may also include other peripheral output devices such as printer 1096, which may be connected through an output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and may include many or all of the elements described above relative to the computer 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in hospitals, offices, enterprise-wide computer networks, intranets and the Internet.

When used in a LAN networking environment, the computer 1010 is connected to the LAN 1071 through a network interface or adapter 1070. When used in a WAN networking environment, the computer 1010 may include a modem 1072 or other means for establishing communications over the WAN 1073, such as the Internet. The modem 1072, which may be internal or external, may be connected to the system bus 1021 via the input interface 1060, or other appropriate mechanism. The communications connections 1070, 1072, which allow the device to communicate with other devices, are an example of communication media, as discussed above. In a networked environment, program modules depicted relative to the computer 1010, or portions thereof, may be stored in the remote memory storage device 1081. By way of example, and not limitation, FIG. 10 illustrates remote application programs 1085 as residing on memory device 1081.

The techniques for training a prompt based classification model described herein may be implemented in part or in their entirety within a computing system such as the computing system 1000 illustrated in FIG. 10. In some embodiments, the computing system 1000 is a server computing system communicatively coupled to a local workstation (e.g., a remote computer 1080) via which a user interfaces with the computing the computing system 1000. For example, the computer 1010 may be configured to present one or more user interfaces at a local workstation (e.g., a client device) for presentation thereat to receive descriptions of the classification model and/or to present outputs of the prompt-based classification model.

In some embodiments, the computing system 1000 may include any number of computers 1010 configured in a cloud or distributed computing arrangement. Accordingly, the computing system 1000 may include a cloud computing manager system (not depicted) that efficiently distributes the performance of the functions described herein between the computers 1010 based on, for example, a resource availability of the respective processing units 1020 or system memories 1030 of the computers 1010. In these embodiments, the documents in the corpus of documents and/or the data associated with the prompt-based classification model may be stored in a cloud or distributed storage system (not depicted) accessible via the interfaces 1071 or 1073. Accordingly, the computer 1010 may communicate with the cloud storage system to access the documents within the corpus of documents, for example, when generating an embedding vector as part of the model training process.

As illustrated, the workspace 110 includes various modules and/or applications that can be executed within the workspace 110. For example, workspace 110 may include the prompt generation application 123, the prompt evaluation application 124, the first generative AI model 125, the second generative AI model 126, the generative AI model training application 128, the documents sampling application 130, and/or the active learning application 150. In some embodiments, the first generative AI model 125 is used to classify documents and the second generative AI model 126 is used to modify prompts based on user comments. In other embodiments, the first generative AI model 125 performs both tasks. Generally, the first generative AI model 125 and the second generative AI model 126 may be large-scale deep neural networks capable of processing and generating media/content such as text, speech, audio, images, videos, etc. In some embodiments, the generative AI model 125 and the generative AI model 126 may include specialized architectural features that improve performance (e.g., content interpretation and generation) within a topic or concept. For example, the generative AI model 125 and the generative AI model 126 may include architectural features that improve chain of thought reasoning by selectively activating portions of the model based on the input to the model. In some instances, these specialized architectural features may result in the generative AI model 125 and the second generative AI model 126 being a “reasoning model.”

In operation, the applications executing within the workspace 110 may be configured to facilitate the classification of documents in the corpus of documents 105. Accordingly, the corpus of documents 105 may be stored at one or more locations, including a local database or cache 118 and/or a remote storage system (not depicted), such as a data lake or other cloud-storage system. Additionally or alternatively, the prompt generation application 123 may be configured to present a user interface by which a user may define prompt criteria that are used to define the classification performed by the prompt-based classification model used in conjunction with the first generative AI model 125 to classify a document. Additionally and/or alternatively, the prompt criteria may define relevancy criteria and issues associated with an inquiry related to the corpus of documents 105 and/or relevancy criteria and issues associated with the classification performed by the prompt-based classification model used in conjunction with the first generative AI model 125 to classify a document or set of documents from the corpus of documents 105. For example, if the corpus of documents 105 is associated with a lawsuit, relevancy criteria may describe how to assess whether a document is relevant to a production request, and the issues may relate to the component elements of the lawsuit that need to be proved. The prompt generation application 123 may supplement the prompt criteria with additional context defining how the first generative AI model 125 is to interpret the prompt criteria to classify a document. The prompt criteria, the additional context, and a target document may be converted into a prompt that is input into the first generative AI model 125. For example, the prompt generation application 123 may include language defining the nature of the prompt criteria, specify what the generative AI model is to output (such as the classification, a description of why the classification was applied, context in the document that led to classification, etc.). The outputs of the generative AI model may then be presented via the review platform 140.

The prompt criteria may be provided by the first user 160 (e.g., via the first user device 165) and/or the second user 170 (e.g., via the second user device 175) via a graphical user interface presented by the prompt generation application 123. Examples of the first user 160 and/or second user 170 include attorneys, prompt engineers, case managers, reviewers, anyone involved in a document review process, etc. Accordingly, examples of the first user device 165 and/or the second user device 175 include user devices of: attorneys, prompt engineers, case managers, reviewers, anyone involved in a document review process, etc. In this regard, examples of the first user device 165 and/or the second user device 175 may include any suitable device(s), such as a computer, a mobile device, a smartphone, a laptop, a phablet, a chatbot or voice bot, etc. The first user device 165 and/or the second user device 175 may include one or more display devices, one or more processors, one or more memories, etc.

The prompt evaluation application 124 may be configured to evaluate the classification performance of a prompt that is generated based on the prompt criteria, with respect to an input set of documents (e.g., an initial set of documents that includes a sufficient number of examples of each classification type with corresponding instructions included in the prompt). Accordingly, the prompt evaluation application 124 may be configured to generate one or more classification performance metrics with respect to the relevance criteria and/or issues associated therewith across the set of documents. For example, the metrics may include recall, precision, elusion, and/or other classification metrics known in the art. It should be appreciated that because a single prompt to the generative AI model 125 may include classification instructions for the relevance criteria and any component issues, modifying the prompt criteria associated with an issue may impact the classification performance with respect to the other classifications defined in the prompt, such as, the relevancy criteria. Accordingly, the prompt evaluation application 124 may be configured to track classification performance (e.g., over time and/or as modifications to the prompt criteria are manually or automatically made) with respect to the relevancy criteria and each issue to detect any potential unintentional performance impacts of modifications to the prompt criteria.

The document sampling application 130 may be configured to obtain samples of documents from the corpus of documents 105. Generally, samples of documents from the corpus of documents 105 may be used (e.g., by the prompt evaluation application 124) to evaluate the classification performance of a prompt (e.g., a prompt generated by the prompt generation application 123). Additionally, the document sampling application 130 may be configured to obtain documents from the corpus of documents 105 on a random basis, a statistical basis, a diversity basis, and/or a deterministic basis. For example, the document sampling application 130 may be configured to obtain an initial random sample of documents from the corpus of documents 105. In some embodiments, the documents sampling application 130 may obtain a sample of documents, or an additional sample of documents, from the corpus of documents 105 based on the classification performance of a prompt. For example, the prompt evaluation application 124 may determine that an initial sample of documents obtained by the document sampling application 130 does not include enough documents associated with a particular issue defined by the prompt criteria, and in response, the documents sampling application 130 may obtain additional documents associated with the particular issue from the corpus of documents 105. In some embodiments, the documents sampling application 130 may be configured to evaluate the prompt criteria and/or the associated classification performance (e.g., performance reports generated by the prompt evaluation application 124), a vector space associated with the corpus of documents 105, a knowledge graph of facts associated with the corpus of documents, and/or or additional information/data of the workspace 110 to determine whether a sample of documents is sufficient.

As illustrated, the workspace 110 includes a review platform 140 to facilitate manual review of any documents. In some embodiments, the review platform 140 may be configured to present one or more graphical user interface (GUIs) on the first user device 165 and/or the second user device 175. Accordingly, the review platform 140 and the first user device 165 and/or the second user device 175 may be communicatively coupled via one or more communication networks. For example, the communication networks one or more wired and/or wireless local area networks (LANs), and/or one or more wired and/or wireless wide area networks (WANs), such as the Internet.

The active learning application 150 may include a trained active learning classifier, such as a support vector machine (SVM), a neural network, or another suitable machine learning classifier. Generally, the active learning application 150 may be configured to train a classifier (e.g., the active learning classifier) using coded documents (e.g., reviewer provided coding decisions for documents via the review platform 140) from the corpus of documents 105. In some embodiments, the active learning application 150 may implement an initial training phase for a machine learning classifier/model, wherein the classifier is trained using a suitable machine learning training algorithm (e.g., logistic regression algorithm). Additionally, the active learning application 150 may be configured to implement an active learning training loop for a machine learning classifier whereby a queue-based strategy to select the most informative documents for review is implemented (e.g., via the review platform 140), documents are labeled by a human reviewer (e.g., via the review platform 140), and the labeled documents are provided to the machine learning classifier training algorithm for further training of the classifier.

Additionally, to determine when the active training loop is complete, the active learning application 150 may validate the trained classifier against a validation set (e.g., labelled documents not used for training) to evaluate the performance of the trained classifier. Based on the evaluation, the active learning application 150 may repeat the active learning training loop until satisfactory performance for the trained machine learning classifier has been reached. It should be noted that the active learning application 150 may implemented as one or more software modules within a cloud and/or distributed computing system. Example techniques for training a machine learning classifier using an active learning training process are described in U.S. application Ser. No. 11/409,589 (Attorney Docket No. 32646/54395), entitled “Methods and Systems for Determining Stopping Point”, filed Oct. 22, 2020, the entire disclosure of which is hereby incorporated by reference.

Furthermore, although the example environment 100 illustrates only one of each of the components, any number of the example components are contemplated (e.g., any number of computing devices, first user devices, second user devices, databases, etc.).

### Example Prompt Criteria

As mentioned above, the first user device 165 and/or the second user device 175 may provide prompt criteria to the prompt generation application 123 to provide a definition for a prompt-based classification model that is used to classify a document via a generative AI model. Broadly speaking, the prompt criteria may include any criteria that may be used to explain how documents may be classified. Examples of the prompt criteria include: setup, case summary, relevance, and/or key documents. Furthermore, each of the prompt criteria may have a criteria category, as will be discussed further below.

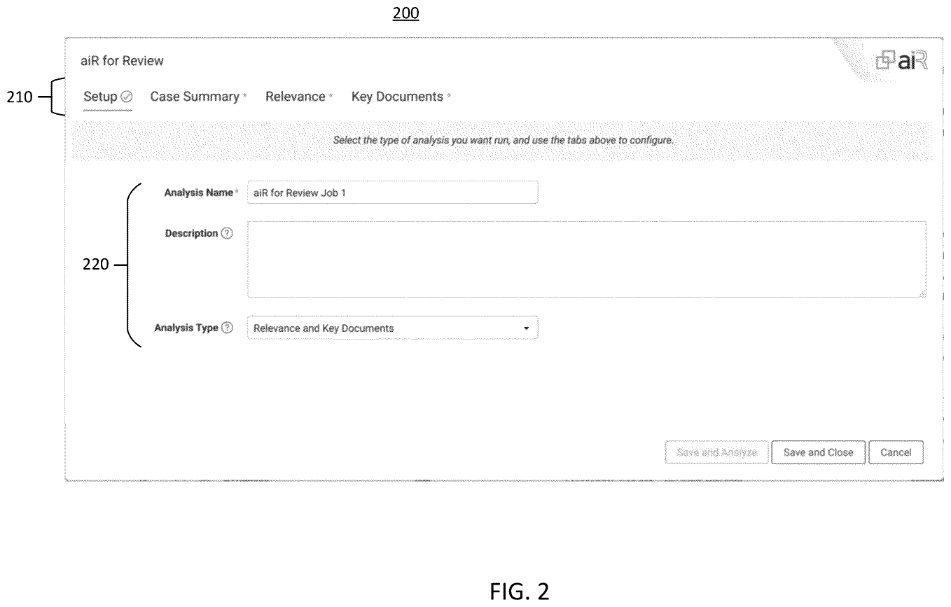

FIG. 2 depicts an example screen 200 (e.g., a prompt criteria editor interface), which may be generated by the prompt generation application 123. As illustrated, the example screen 200 includes selectable categories 210 corresponding to different types of user inputs related to the prompt-classification model that may be specified via the prompt generation application 123 (e.g., setup, case summary, relevance, and key documents). In the illustrated example, the example screen 200 is configured to receive setup input.

As illustrated, the example screen 200 enables the user to enter the input data 220 defining the configuration of the prompt-based classification model. It should be appreciated that the input data 220 may define information associated with the prompt-based classification model that is not used within the prompt-based classification model itself.

In the illustrated example, the input data 220 includes an analysis name for naming the prompt-based classification model. The name may be associated with a classification model object that is maintained in the workspace 110. The name may be used to distinguish between multiple prompt-based classification models within the workspace 110.

The input data 220 also includes description field to provide a high-level description of the prompt-based classification model. The description may be provided such that users are able to identify the particular analysis performed by the prompt-classification model, for example, such that a user that has access to multiple classification models (prompt-based or traditional ML) understands the purpose of the defined prompt-based classification model. For example the description may state, e.g., “1,000,000 documents for case no. xx-xxxx will be reviewed to respond to discovery request pertaining to topic ABC.”

It should be appreciated that corpus of documents the model acts upon may change over time (e.g., as additional documents are collected or the scope of the inquiry changes). Accordingly, in the prior example, if workspace 110 ingested more than 1,000,000 documents, the model can still be used to classify the documents in excess of 1,000,000. Additionally, in some embodiments, the model may be stored and utilized with completely different datasets than the dataset for which the model was created.

The analysis type input data 220 is a drop down that is used to signal to the prompt generation application 123 the type of classification task being performed by the prompt-based classification model. The selection of the analysis type may change the specific fields of prompt criteria presented to the user and/or change the additional context added to the prompt criteria by the prompt generation application 123. For example, the analysis type drop down may enable the user to specify analysis types of: (i) relevance and key documents, (ii) confidential, (iii) privileged, etc.

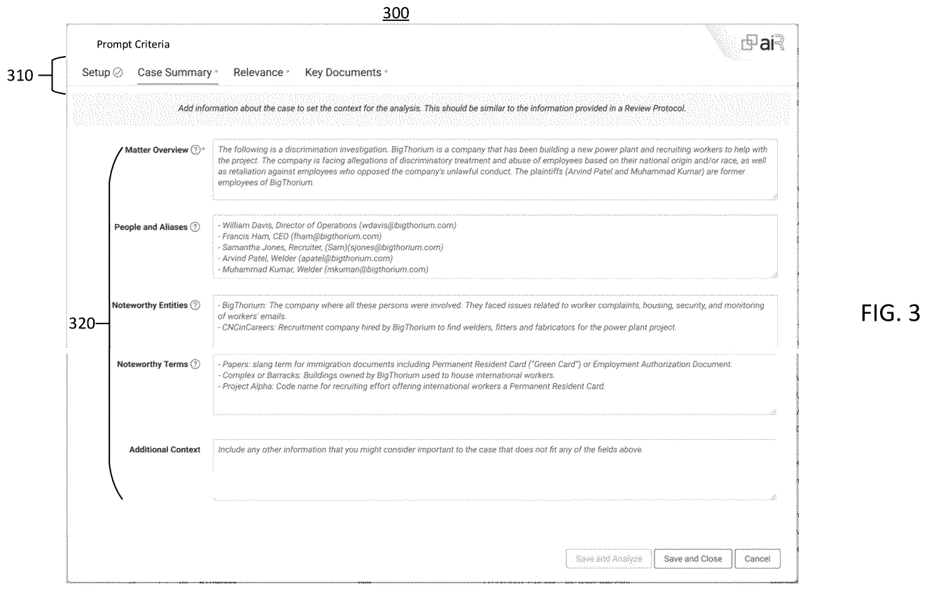

FIG. 3 depicts an example screen 300 (e.g., a prompt criteria editor interface), which may be generated by the prompt generation application 123. As illustrated, the example screen 300 includes selectable categories 310 corresponding to different types of user inputs that may be specified via the prompt generation application 123 (e.g., setup, case summary, relevance, and key documents). In the illustrated example, the example screen 300 is configured to receive user inputs related to case summary prompt criteria.

As illustrated, the example screen 300 enables the user to enter case summary prompt criteria 320. The case summary prompt criteria may relate to a summary of the case.

As one example, the prompt criteria 320 may include a matter overview field. The matter overview field enables the user to enter a description over the overall matter the associated with the corpus of the documents. That is, the matter overview may be used to describe the overall nature of the dispute, as opposed to the specific inquiry to which the prompt-based classification model is being used respond. Accordingly, the matter overview field may include a description of the basic facts of the case, allegations made against a defendant, etc.

As another example, the prompt criteria 320 may include a people and aliases field via which the user defines key individuals. For example, the same individual may be referenced in different manners across the corpus of documents 105 (e.g., full name vs. nickname, work email vs. personal email, etc.). Accordingly, the aliases field enables the user to signal to the generative AI model that different aliases of the individual refer back to the same person. The aliases filed also enable the user to input job titles and/or roles associated with the individual to provide additional context as the role of the listed individuals.

As another example, the prompt criteria 320 includes a noteworthy entities field that enables the user to define entities (such as companies, law firms, etc.) related to the matter. For example, the user may define the entity's relationship to the matter and provide a brief description of their operations. Similar to the aliases field, the entities filed may enable the user to define other names for the entities (e.g., a d/b/a name, a shorthand, a colloquial name, etc.).

As yet another example, the prompt criteria 320 also includes a noteworthy terms field. This enables the user to provide context related to specific terms that is particular to matter and would not be understood from the term's general usage. For example, the user may define slang terms used in the field and/or by the individuals and/or entities, project names used to refer to particular undertakings, codewords used to refer to specific activities performed by individuals.

Additionally, the prompt criteria 320 may include an “additional context” field that enables the user to define any other information that may be important for the generative AI models to be aware of when performing the classification.

It should be appreciated that in some embodiments, the workspace 110 includes a set of objects defining the people, entities, and/or terms. In these embodiments, the prompt generation application 123 may parse the fields to identify specific individuals, entities, and/or terms entered by the user and provide additional context maintained in the workspace objects.

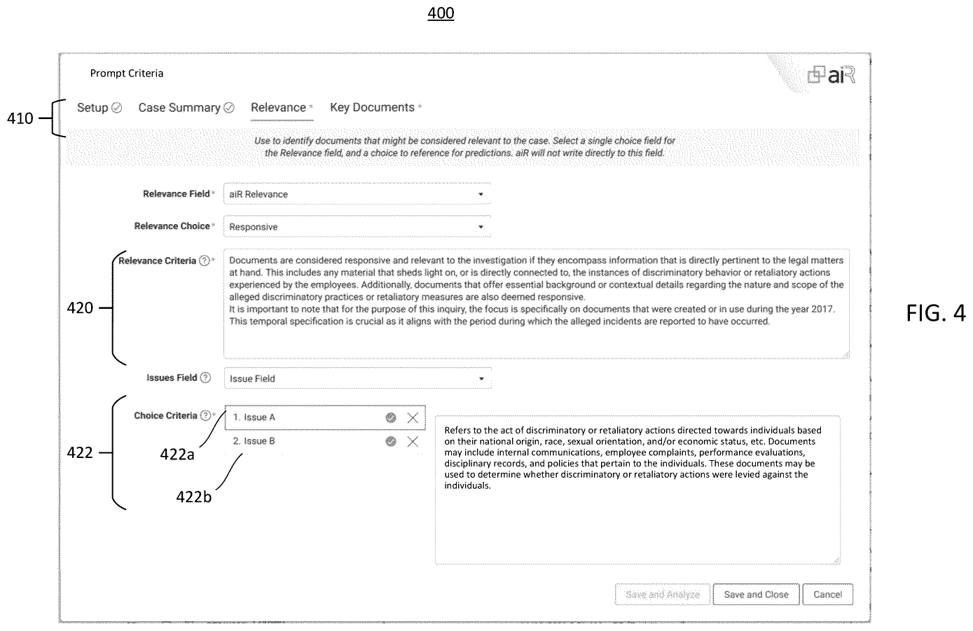

FIG. 4 depicts an example screen 400 (e.g., a prompt criteria editor interface), which may be generated by the prompt generation application 123. As illustrated, the example screen 400 includes selectable categories 410 (e.g., setup, case summary, relevance, and key documents) corresponding to different types of user inputs that may be specified via the prompt generation application 123. In the illustrated example, the example screen 400 is configured to receive user inputs defining relevance as it relates to the inquiry.

As illustrated, the example screen 400 enables the user to enter relevance prompt criteria 420, 422. It should be appreciated that “relevance” may be different depending on the particular inquiry the prompt-based classification model is intended to classify. For example, the criteria 420 may be used to define relevance as it relates to responsiveness to an eDiscovery inquiry. Accordingly, the relevance field 420 may enable the user to input a text description defining the scope of relevant documents (e.g., a subject matter discussed in the document, a person or entity involved in the communication, timing criteria associated with the document, etc.). The criteria 420 may be used by the generative AI models when deciding whether or not an input document is relevant.

As another example, the example screen 400 enables the user to enter choice prompt criteria 422 related to individual issues (e.g., issue A 422a, and issue B 422b) that are related to the matter. For example, the issues may relate to specific elements that need to be proven as part of prima facie case or an affirmative defense in an eDiscovery matter. Accordingly, the criteria 422 enable the user to enter a description defining how to identify documents that are relevant to each issue associated with the prompt-based classification model.

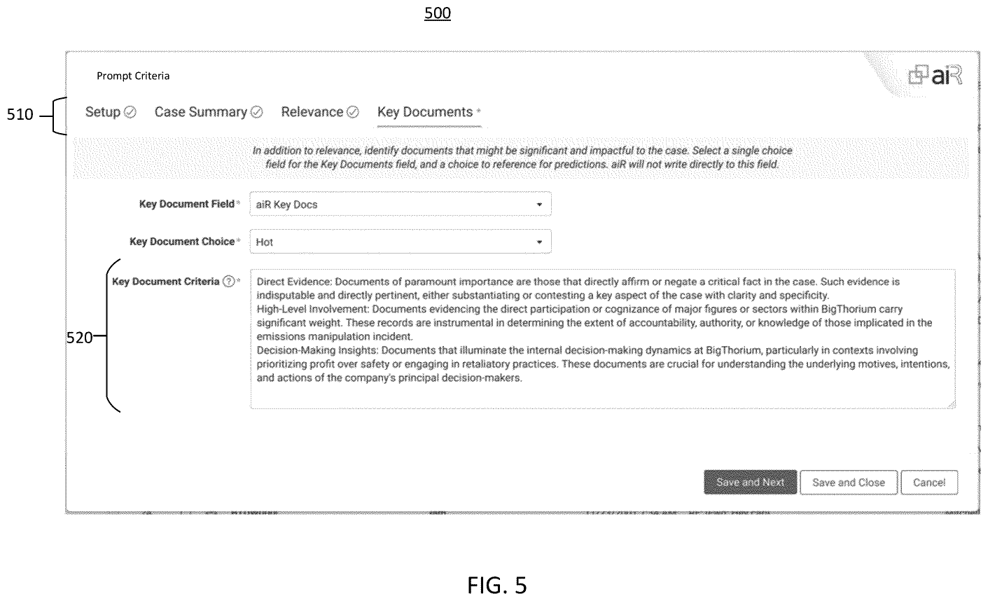

FIG. 5 depicts an example screen 500 (e.g., a prompt criteria editor interface), which may be generated by the prompt generation application 123. As illustrated, the example screen 500 includes selectable categories 510 (e.g., setup, case summary, relevance, and key documents). In the illustrated example, the example screen 500 may be configured to receive user inputs defining key documents prompt criteria. As indicated in FIG. 5, a key document is a document that is significant to the matter, such as a document that is likely to be cited in a brief and/or presented as an exhibit. Accordingly, the example screen 500 includes a field via which the user is able to input information defining the types of documents that are likely to be “key documents” in the matter.

It should be appreciated that the relevance criteria 420, the issue criteria 422, and key document criteria 520 relate to different inquiries into the corpus of documents 105. As will be explained below, the prompt generation application 123 may be configured to supplement the criteria 420, 422, and 520 with additional context such that a single prompt causes the generative AI model is able to perform each respective classification. Thus, rather than training and invoking a separate machine learning classifier for each inquiry, the prompt-based classification model enables the workspace 110 to perform multiple classifications of a document with a single call to the generative AI application programming interface (API).

### Example Methods

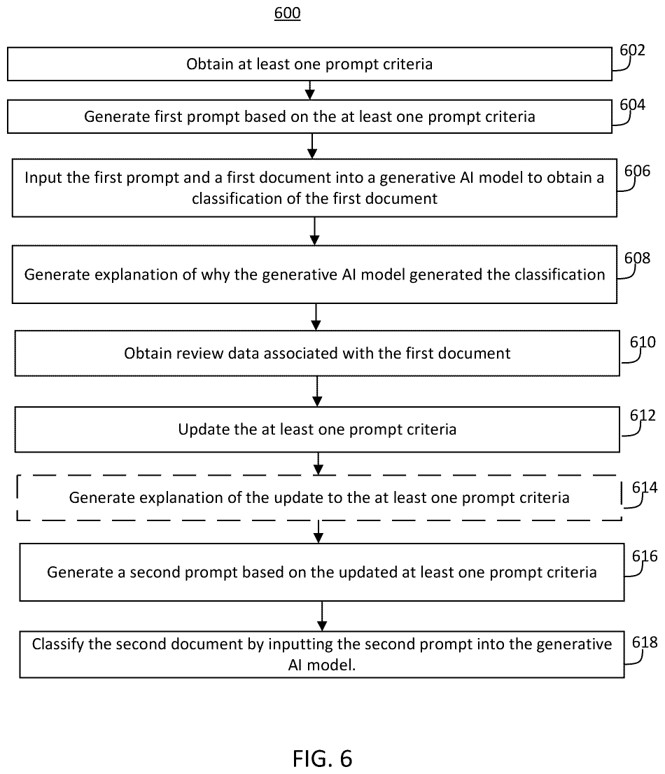

FIG. 6 illustrates a flow diagram representing an example computer-implemented method 600 for using a generative artificial intelligence (AI) model to classify documents and/or provide explanations. The example method 600 may be implemented by a computing environment 100 hosting the workspace 110. For example, the computing environment 100 may execute one or more of the applications 123, 124, 125, 126, 128, 130, 140, or 150 to perform functions described with respect to the method 600.

The example method 600 may begin at block 602 when the prompt generation application 123 obtains at least one prompt criteria. Examples of the prompt criteria are described elsewhere herein, and may include: case summary criteria 320 of FIG. 3; relevance criteria 420 and/or issue criteria 422 of FIG. 4; and key documents criteria of FIG. 5.

In some embodiments, the prompt generation application 123 obtains the at least one prompt criteria by receiving the at least one prompt criteria from the first user device 165 and/or the second user device 175. For example, the first user 160 and/or second user 170 may enter the prompt criteria into a prompt criteria editor interface (e.g., any of screens 200, 300, 400, 500, etc.) of the first user device 165 and/or the second user device 175, which may be sent to the workspace 110.

At block 604, the prompt generation application 123 generates a first prompt based upon the at least one prompt criteria. In some examples, the prompt is generated by supplementing the at least one prompt criteria with additional context. For example, the additional context may define how a generative AI model is to interpret each of the at least one prompt criteria. For example, the additional context may be text defining what it means for a document to be “relevant.” As another example, the prompt generation application 123 may parse the input criteria to provide additional context from the workspace 110 (e.g., additional context data stored at the database 118).

As another example, the additional context may provide a rubric for how a generative AI is to output the classification. For example, the rubric may define a 5-point scale used to classify documents. In this example, 0 may correspond to junk, 1 may correspond to documents that are non-responsive, 2 may correspond to documents that are borderline responsive, 3 may correspond to documents that are responsive, and 4 may correspond to documents that are very responsive. Of course, other scales and/or rubrics may be defined based on the particular inquiry being performed. Accordingly, the additional context may define the meaning of each classification output to a generative AI model. As a result, the classification outputs of the generative AI model are in a predictable and consistent format.

At block 606, the prompt generation application 123 inputs the prompt and a first document into the generative AI model 125 to obtain a classification of the first document. The first document may be part of a corpus of documents (e.g., stored at the database 118, the memory 122, or any other suitable storage location). The classifications may be any suitable classifications. In some examples, the classifications are binary (e.g., responsive or not responsive to an inquiry, etc.). In other examples, the classification may include a gradient of certainty with respect to the classification, for instance, classifications may include: junk; responsive; not responsive; likely responsive; likely not responsive, borderline; very responsive; etc. Examples of other types of classification include privileged vs. not privileged; confidential vs. not confidential; etc. As described above, the classification may be in accordance with a rubric defined in the additional context generated by the prompt generation application 123.

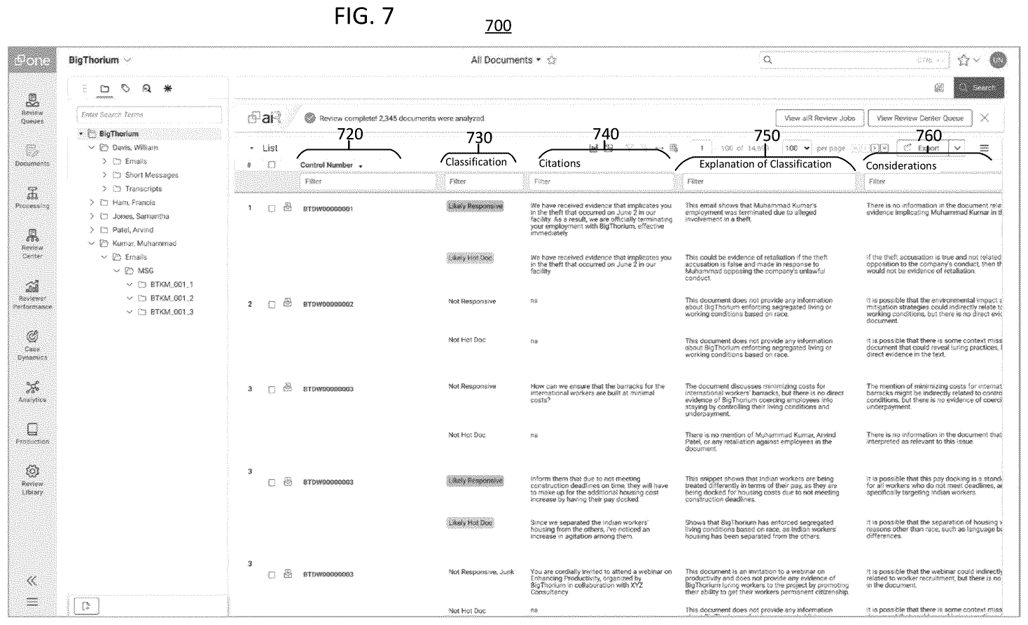

At block 608, the first generative AI model 125 generates an explanation of why the first document was classified as it was. The explanation may be generated using the same prompt that produced the classifications. Accordingly, the prompt generation application 123 may be configured to parse the outputs of the generative AI model 125 to segment the output into the various fields described herein, including those illustrated in FIG. 7. For example, the generative AI model may output a brief summary explaining the classification, identify the criteria that most heavily influenced the classification, identify the portion of the document that resulted in the classification, identify a potential counter-argument or shortcoming in its classification, and/or provide other types of data explaining the classification. It should be appreciated that the prompt generation application 123 may be configured to supplement the prompt criteria with instructions for generating the explanatory information associated with the classification when creating the prompt that is input into the generative AI model.

In some embodiments, the generative AI model 125 also outputs a confidence score associated with a confidence in the output classification. It should be appreciated that because the generative AI model 125 is not a traditional machine learning classifier model (such as a support vector machines (SVM) classifier); for example, the score is generally not tied to a mathematical meaning. That is, while the prompt engineering techniques disclosed herein may cause the generative AI model 125 may consistently output confidence scores, there is no inherent relationship to the confidence scores when applying traditional machine learning classifiers. Accordingly, techniques disclosed herein relate to analyzing the confidence scores across a plurality of documents to generate a factor that normalizes the output of the generative AI model 125 to a scale that reflects the traditional understanding classifier confidence scores. However, in some variations, the prompt generation application 123 supplements the prompt with additional context to such that the confidence scores produced by the generative AI model 125 may be utilized as a classification probability.

The classification and/or the explanatory information may be presented to a user (e.g., via a document review user interface of the review platform 140). For example, FIG. 7 shows an example screen 700 indicating the classifications and explanatory information for a plurality of documents included in the corpus of document. For example, the example screen 700 may include columns that, for each classified document, indicate, a control number 720, a classification 730, a citation to the document 740 indicative of a portion of the document that influenced the classification 730, an explanation 750 of why model classified the document with the classification 730, and consideration 760 referencing potential shortcomings or defects in the reasoning that resulted in the classification. It should be appreciated that the columns may be sortable to facilitate the identification documents associated with different classifications and/or explanatory information. For example, a user may want to review the classifications 730 applied to each document classified as “responsive.”

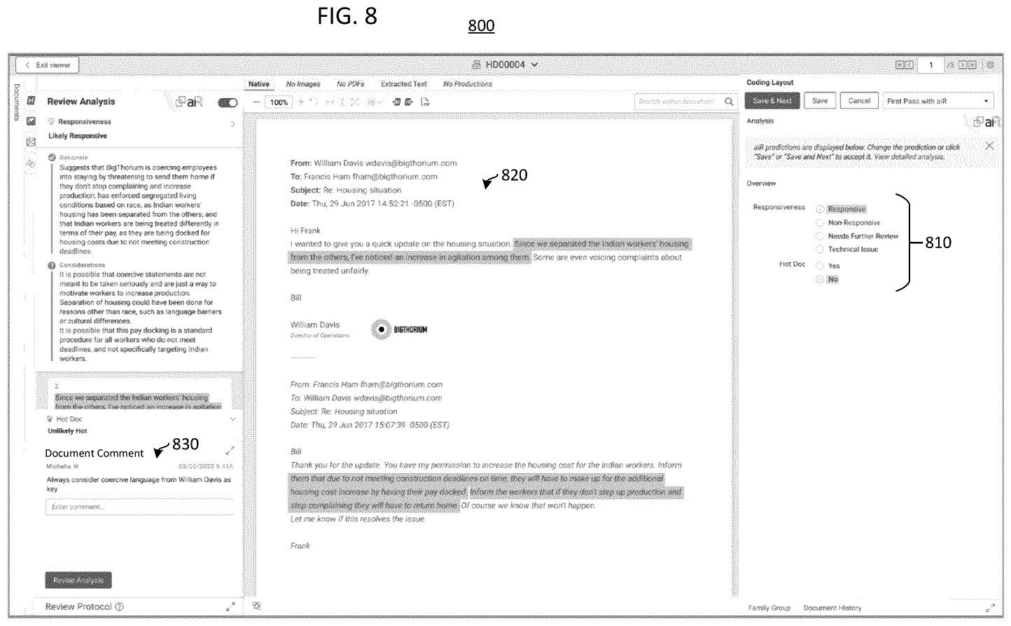

At block 610, the prompt generation application 123 obtains review data associated with the first document. For example, FIG. 8 shows an example screen 800 presented by the review platform 140 displaying the classification and the explanatory information for the classifications associated with a single document. As illustrated, the example screen 800 enables a user to review the classification output by the generative AI model 125 and provide review data indicative of the accuracy of the classification. For example, the example screen 800 includes a manual classification interface 810 (e.g., a document review interface) that enables the user to manually apply a classification label to the displayed document. As illustrated, the interface 810 may include an indication of the classification applied the generative AI model 125. Accordingly, the review data may include an indication of whether or not manual classification of the document agrees with the classification applied by the generative AI model.

The review data related to whether or not the user and the generative AI model 125 may be used, for example, to determine one or more statistics indicative of whether the generated prompt exhibits sufficient performance to be used to classify the corpus of documents 105. It should be appreciated that the statistics generated related to performance of the generative AI model 125 as compared to the human reviewer may be the same statistics used when evaluating the performance of a traditional ML classifier. Accordingly, by ensuring that the prompt-based classification model causes the generative AI model 125 to meet the same performance metrics as traditional ML classifiers, a user of the prompt-based classification model is able to provide defensible confidence in the accuracy of the model.

As another example of review data, the example screen 800 includes a comment interface 830 that enables a reviewer to input a comment explaining the error in the reasoning output by the generative AI model 125 and/or how the reviewer would update the prompt criteria to prevent the generative AI model from misclassifying the document. In some embodiments, these comments may be provided to a case administrator to resolve into a final version of prompt-based classification model. In other embodiments, the reviewer may be able to directly update the prompt criteria. In these embodiments, the review platform 140 may be able to generate review data for multiple versions of the prompt-based classification model to identify which version performs the best and/or performs the best with respect to particular documents and/or inquiries.

It should be appreciated that obtaining an explanation related to the reasoning behind the classification is not generally possible when using traditional ML classifiers. In systems using only traditional ML classifiers, the output is typically a classification and/or a confidence score in the classification. Accordingly, the user is provided little to no context as to why the ML classifier applied a particular label to a document. As a result, it is often difficult to troubleshoot or explain any discrepancy between the trained ML classifier and a human reviewer (should one arise).

Returning now to FIG. 6, at block 612, the prompt generation application 123 updates the at least one prompt criteria based on the classification of the first document and/or the review data. For example, if a document comment indicated to mark emails from a previously-unknown alias CEO alias as responsive, the people and aliases prompt criteria may be updated to include the new alias. In another example, if a threshold number of documents referencing XYZ corp. were classified as responsive, the noteworthy entities prompt criteria may be updated to include XYZ corp.

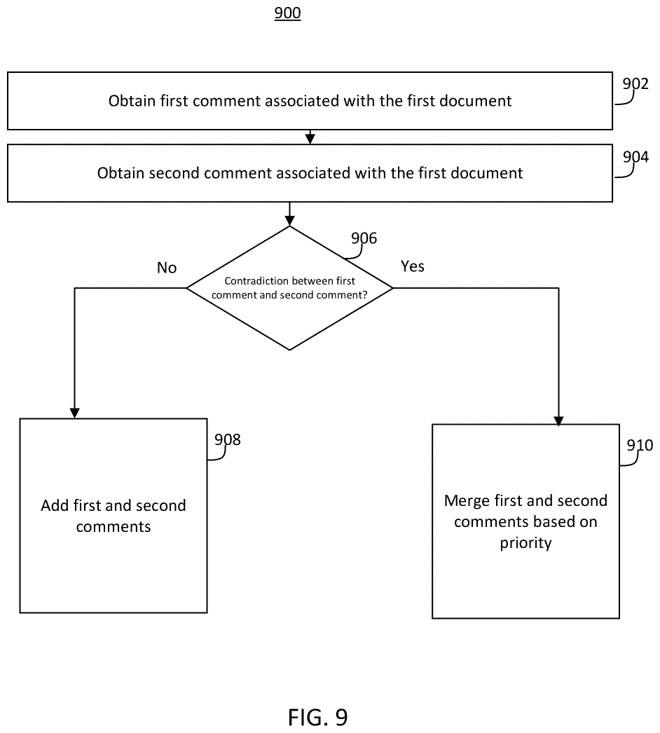

To this end, FIG. 9 depicts an example implementation of merging document comments. At block 902, the prompt generation application 123 obtains first review data comprising a first comment associated with the first document. At block 904, the prompt generation application 123 obtains second review data comprising a second comment associated with the first document.

At block 906, the first generative AI model 125 and/or second generative AI model 126 determines if contradiction exists between the first comment and the second comment. Examples of contradictions include: different classifications of the same document (e.g., the first comment indicates the first document should be classified as responsive, but the second comment indicates the first document should be classified as not responsive); contradictory indications as to how to classify a type of document (e.g., one comment indicates that spreadsheets are responsive, whereas another comment indicates that spreadsheets are not responsive); contradictions regarding a person (e.g., one comment indicates that emails from the CEO are responsive, and another comment indicates that they are not responsive); etc.

If no contradiction is found, the first and second comments are added together (block 908). If a contradiction is found, the first comment and the second comment are merged based on a priority associated with each comment (e.g., a priority associated with the users, user profiles, and/or user devices that submitted the document comments) (block 910). For example, a CEO may utilize different names or titles depending on the audience of their communication. If a higher ranking attorney (e.g., having a higher priority) indicated that emails using a particular alias (such as an alias not included in the criteria 320) as being responsive as being generated by the CEO, but a lower ranking attorney (e.g., having a lower priority) indicated that such emails were not responsive, the conflict would be resolved in favor of the higher ranking attorney, whereby the merged comments would indicate that emails from the previously-unknown alias should be classified as responsive. In some such examples, noncontradictory parts of the comments are still included in the merged document comments. For instance, if, in the preceding example, the lower ranking attorney's comment had included additional portions beyond the indication that emails from the CEO were not responsive, the additional portions would be included in the merged comments.

In some embodiments, the updating the at least one prompt criteria includes generating a proposed update to the at least one prompt criteria by inputting, into a generative AI model (such as the generative AI model 125 or the generative AI model 126), the prompt criteria and any document comments to obtain one or more proposals for resolving the comments. The proposed updates to the at least one prompt criteria may be presented to a user 160, 170 via a display (e.g., via a prompt criteria editor interface) of the user device 165, 175. The user 160, 170 may, via a display (e.g., via a prompt criteria editor interface) of the user device 165, 175, accept (e.g., confirm that the proposed update is acceptable), reject, or modify the proposal.

At optional block 614, the first generative AI model 125 and/or second generative AI model 126 generates an explanation of the update to the at least one prompt criteria. For example, the explanation may explain that the one or more prompt criteria has been updated to include all emails from the CEO because a number of emails from the CEO have been classified as responsive (e.g., by the user 160, etc.).

Furthermore, in some embodiments, different permission levels are granted to different users. For example, a first permission level may be granted to a first user profile associated with a first user 160, wherein the first permission level allows the first user profile to generate review data but not modify the at least one prompt criteria. Further in this example, a second user profile associated with a second user 170 may be granted a second permission level, wherein the second permission level allows the second user profile to both generate review data and modify the at least one prompt criteria.

At block 616, after updating the prompt criteria to resolve any comments and/or other review data (either manually via a review administrator and/or via AI-assisted techniques), the prompt generation application 123 generates a second prompt based on the updated at least one prompt criteria. The second prompt may be generated as described above with respect to block 604 (e.g., by supplementing the at least one prompt criteria with additional context).

At block 618, a second document is classified by inputting the second document and the second prompt into the generative AI model 125. In some embodiments, block 618 repeats on a corpus of documents (e.g., the generative AI model 125 classifies one or more documents of the corpus of documents).

Following block 618, the example method 600 may return to (e.g., iterate back to) any of the preceding blocks. For example, the example method 600 may return to block 610 to obtain review data of the first document and/or any other document. In this regard, it should be understood that, at this iteration, in some embodiments, rather than obtain review data of the first documents, review data of the second document is obtained.

Moreover, in some embodiments, the one or more processors 120 (e.g., via the prompt generation application 123, the first generative AI model 125, and/or the second generative AI model 126) may determine that the prompt is acceptable. For example, the first and second documents may be included in a plurality of training documents. The plurality of training documents may be classified by inputting the training documents and the second prompt into the generative AI model 125. The prompt generation application 123 may then: obtain review data associated with the plurality of training documents; generate one or more validation metrics based on a comparison of the review data and the classifications of documents of the plurality of training documents; and then determine that the second prompt is acceptable based on the one or more validation metrics.

In addition, it should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein. It should further be appreciated that the blocks of the signal diagrams and/or flowcharts may be performed in any suitable order.

### Exemplary Training of An Exemplary Generative AI Model

In most embodiments, large language models (LLMs) and/or large multimodal models (LMMs) of the first generative AI model 125 and/or second generative AI model 126 are off-the-shelf, or pretrained (at least in part). However, in some embodiments, the generative AI model training application wholly or partially trains the LLM(s), the first generative AI model 125, and/or the second generative AI model 126. It should be appreciated that while the instant disclosure occasionally refers to LLMs accepting text-based prompts, it should be appreciated that such references envision the alternative use of LMMs to additionally accept image data as part of a prompt.

The generative AI models 125, 126 may be used to, among other things: (i) generate prompts (e.g., from prompt criteria); (ii) generate updates (or proposed updates) to prompt criteria; (iii) generate explanations of updates to prompt criteria; (iv) generate explanations of classifications; and/or (v) classify documents. It should be appreciated that although the following discussion refers to training of the generative AI model 125, it applies equally to training the generative AI model 126. It should further be appreciated that although the following discussion may refer to an AI model, it should be understood that it applies equally to an ML model.

To this end, the generative AI model 125 may output text (e.g., (i)-(iv) above), and/or classifications (e.g., (v) above). The training of the generative AI model 125 for both will be described below. Furthermore, in some implementations, the training for the classifications output uses a validation training set, whereas training for the text output does not use a validation training set. The validation training set may include, for example, documents, and corresponding classifications of the documents.

Regarding text output, the generative AI model 125 may be trained by generative AI model training application 128 using large training datasets of text which may provide sophisticated capability for natural-language tasks, such as answering questions and/or holding conversations. The generative AI model 125 may include a general-purpose pretrained LLM which, when provided with a starting set of words as an input, may attempt to provide an output (response) of the most likely set of words that follow from the input. The input may additionally or alternatively include a document, and a classification thereof. In one aspect, the input may be provided to, and/or the response received from, the generative AI model 125, via a user interface of the workspace 110. This may include a user interface device operably connected to the server via an I/O module. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances, which may require the generative AI model 125 to keep track of an entire conversation history as well as the current state of the conversation. The generative AI model 125 may rely on various techniques to engage in conversations with users, which may include the use of short-term and long-term memory. Short-term memory may temporarily store information (e.g., in the memory 122) that may be required for immediate use and may keep track of the current state of the conversation and/or to understand the user's latest input in order to generate an appropriate response. Long-term memory may include persistent storage of information (e.g., the database 118) which may be accessed over an extended period of time. The long-term memory may be used by the generative AI model 125 to store information about the user (e.g., preferences, chat history, etc.) and may be useful for improving an overall user experience by enabling the generative AI model 125 to personalize and/or provide more informed responses.

In some embodiments, the system and methods to generate and/or train the generative AI model 125 (e.g., via the generative AI model training application 128) which may be used in the generative AI model 125, may include three steps: (1) a supervised fine-tuning (SFT) step where a pretrained language model (e.g., an LLM) may be fine-tuned on a relatively small amount of demonstration data curated by human labelers to learn a supervised policy (SFT AI model) which may generate responses/outputs from a selected list of inputs. The SFT AI model may represent a cursory model for what may be later developed and/or configured as the generative AI model 125; (2) a reward model step where human labelers may rank numerous SFT AI model responses to evaluate the responses which best mimic preferred human responses, thereby generating comparison data. The reward model may be trained on the comparison data; and/or (3) a policy optimization step in which the reward model may further fine-tune and improve the SFT AI model. The outcome of this step may be the generative AI model 125 using an optimized policy. In one aspect, step one may take place only once, while steps two and three may be iterated continuously, e.g., more comparison data is collected on the current generative AI model 125, which may be used to optimize/update the reward model and/or further optimize/update the policy.

### Iterative Prompting of an Example Generative AI Model

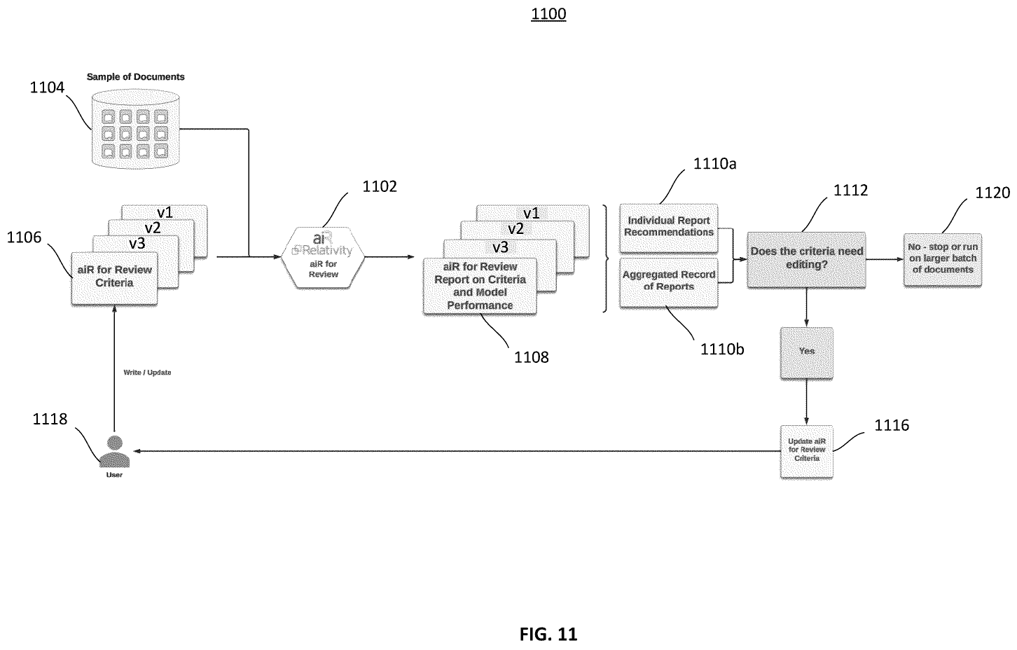

FIG. 11 depicts an iterative prompting approach 1100 for a prompt-based classification model 1102 (e.g., the prompt-based classification model used in conjunction with the first generative AI model 125) for refining prompts input to the classification model 1102. Generally, the classification model 1102, and moreover the iterative prompting approach 1100, may be implemented for responding to a request for production during litigation. Accordingly, a sample of documents 1104 may be processed using the classification model 1102. More particularly, the sample of documents 1104 may be evaluated using a prompt derived from prompt criteria 1106 (e.g., relevance criteria 420 and/or issue criteria 422) that is input to the classification model 1102. In response to the input prompt, the classification model 1102 may output a classification of each input document (e.g., each document in the sample of documents 1104). As the prompt criteria 1106 are iteratively updated, previous versions of the prompt criteria 1106 are stored to evaluate which prompt criteria exhibit the strongest classification performance.

The classification model 1102 may be a generative artificial intelligence model (AI), a language model (LM), and/or a large language model (LLM), etc., capable of classifying a document based upon an input natural language prompt. Generally, a prompt generated based upon the prompt criteria 1106 may be input with each document of the sample of documents 1104 to the classification model 1102 to obtain a set of classifications for the sample of documents 1104. As described herein, the prompt criteria 1106 may include a set, or sets, of instructions that define how a document should be analyzed and/or classified by the classification model 1102 with respect to relevancy requirements and/or the descriptions of the issues (e.g., relevance criteria 420 and/or issue criteria 422). The sample of documents 1104 may be associated with a set of ground truth classification (e.g., review data associated with the sample of documents 1104). For example, each document from the sample of documents 1104 may be reviewed and labelled by a user (e.g., the user 1118, the first user 160 of FIG. 1, etc.) with respective classifications. In some embodiments, the review data may be associated with any number of inquiries or classifications defined by the prompt criteria 1106.

Based upon the classifications output by the classification model 1102 and the associated ground truth data, the prompt evaluation application 124 may generate performance reports 1108 for the prompt criteria 1106. Generally, the performance reports 1108 indicate the performance of the classification model 1102 at classifying documents in the sample of documents 1104 based on the prompt criteria 1106. For example, the performance reports 1108 may be generated by performing mathematical calculation to determine accuracy metrics, precision metrics, recall metrics, elusion metrics, other suitable classification metrics, and/or some combination thereof. In some embodiments, such classification metrics may be required to meet a particular threshold value (e.g., a customizable threshold value, a court ordered threshold value, etc.). Accordingly, the performance reports 1108 may track the progress of different versions of the prompt criteria toward reaching such threshold.

The performance reports 1108 may be analyzed to generate individual report recommendations 1110a and an aggregated record of reports 1110b. The individual report recommendations 1110a may indicate the performance of the classification model 1102 (e.g., the performance of the classification model 1102 at classifying documents in the sample of documents 1104) with respect to the relevancy requirements and/or the description of an issue defined by the prompt criteria 1106 (e.g., with respect to issue A 422a and issue B 422b of FIG. 4). The individual report recommendations 1110a are stored and associated with the respective version of the prompt criteria 1106. In some embodiments, the individual report recommendations 1110a may be generated based upon the classification metrics from the performance reports 1108, and generally, may include a description of how the prompt criteria 1106 performed with respect to particular types of documents and/or content therein. For example, the individual report recommendations 1110a may be generated via inputting the performance reports 1108 into a generative AI model (which maybe the classification model 1102, but may be a different model) along with a prompt asking the generative AI model to analyze particular aspects of the performance (e.g., summarizing the documents incorrectly classified by the classification model, summarizing the documents that were classified as borderline, summarizing the ability to detect particular issues, etc.). As a result, users are provided guidance with respect to how to update the prompt criteria 1106 to improve performance with respect to the classification metric.

The aggregated record of reports 1110b may indicate the performance of the different versions of prompt criteria 1106 over time. For example, the aggregated record of reports 1110b may enable tracking of which versions of the prompt criteria exhibit the best classification performance with respect to the component criteria/classifiers (e.g., relevance criteria 420, and issue criteria 422 of FIG. 4) included in the prompt criteria 1106. The aggregated record of reports 1110b may summarize the performance reports 1108 and the individual report recommendations 1110a, and may indicate whether the classification metrics (e.g., accuracy metrics, precision metrics, recall metrics, etc.) are meeting respective and/or aggregate performance metric thresholds. In some embodiments, the individual report recommendations 1110a and/or the aggregated record of reports 1110b may include a natural language summary indicating components of the prompt criteria 1106 that negatively impacted performance of classifying documents in the sample of documents 1104. Additionally, the aggregated record of reports 1110b may be generated by inputting multiple performance reports 1108 with the same prompt used to generate an individual report recommendation 1110a.

At block 1112, based on the performance reports 1108, the individual report recommendations 1110a, and the aggregated record of reports 1110b, the prompt evaluation application 124 may determine whether the prompt criteria 1106 needs to be edited or updated. In some embodiments, classification performance (e.g., performance reports 1108 and the individual report recommendations 1110a) of the current prompt criteria 1106 (e.g., version 4 of the prompt criteria 1106) may be compared to classification performance of an earlier version of the prompt criteria (e.g., version 1, 2, and/or 3 of the prompt criteria 1106). In some embodiments, the aggregated record of reports 1110b may be analyzed to compare classification performance of the current prompt criteria 1106 to classification performance of earlier versions of the prompt criteria. Based on the comparison, it may be determined whether the classification performance of the current prompt criteria 1106 has improved, and/or not degraded, with respect to the classification metric threshold.

When the classification performance has not met the classification metric threshold, it may be determined that the prompt criteria 1106 needs to be updated and/or edited. For instance, the current prompt criteria 1106 (e.g., version 4 of the prompt criteria 1106) may be an updated version of the earlier prompt criteria 1106. In some embodiments, updating the prompt criteria 1106 may include identify a particular prompt criterion that needs updating and/or automatically suggest an updated definition of the prompt criteria 1106. In response, the user may modify the prompt criteria 1106 and/or accept a suggested modification of the prompt criteria 1106 to create a new version thereof. In response, the functionality described with respect to blocks 1102-1110 may be repeated with respect to the new version of the prompt criteria.

On the other hand, if the prompt criteria 1106 does not need to be updated (block 1120) (e.g., the classification model 1102 satisfied the classification metric threshold), the prompt criteria 1106 may be approved and used to obtain classifications of additional documents in the corpus of documents (e.g., documents from the corpus of documents 105 not included in the sample of documents 1104).

### Example Methods

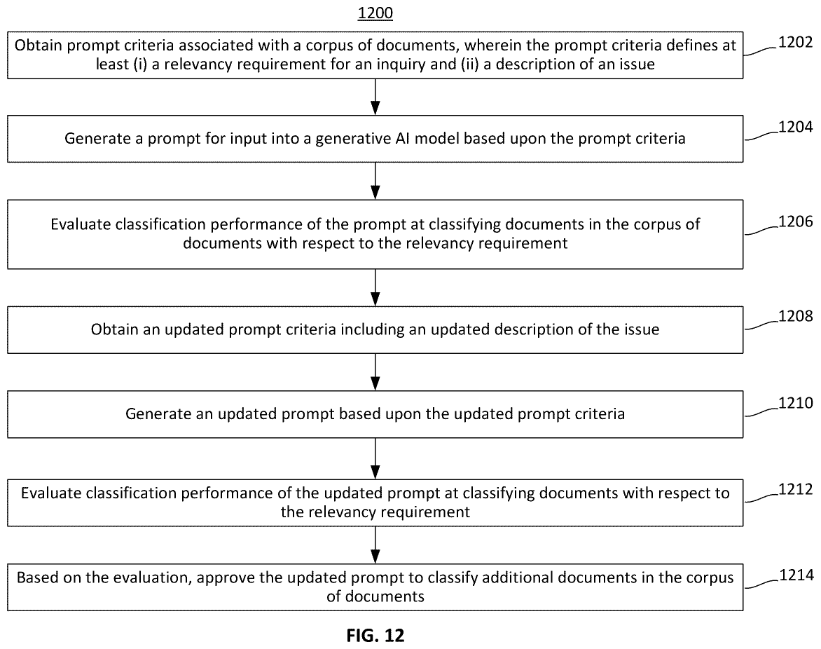

FIG. 12 illustrates a flow diagram representing an example computer-implemented method 1200 for an iterative prompting approach for a prompt-based classification model. The example method 1200 may be implemented by the computing environment 100 hosting the workspace 110. For example, the computing environment 100 may execute one or more of the applications 123, 124, 125, 126, 128, 130, 140, or 150 to perform functions described with respect to the method 1200.

The example method 1200 may begin at block 1202 when the prompt generation application 123 obtains prompt criteria associated with a corpus of documents, wherein the prompt criteria define at least (i) a relevancy requirement for an inquiry and (ii) a description of an issue. Examples of the prompt criteria are described elsewhere herein, and may include: case summary criteria 320 of FIG. 3; relevance criteria 420 and/or issue criteria 422 of FIG. 4; and key documents criteria of FIG. 5.

At block 1204, the prompt generation application 123 generates a prompt for input into the generative AI model (e.g., the generative AI model 125) based upon the prompt criteria. In some examples, the prompt is generated by supplementing the prompt criteria with additional context. For example, the additional context, or a portion of the additional context, may be a set of rules that instruct the generative AI model to reach intermediate conclusions before outputting a classification for a document. Continuing with this example, the intermediate conclusions may include citations to documents in the corpus of documents that support the intermediate conclusions, rationales behind the intermediate conclusions, and/or considerations accounted for when making the intermediate conclusions. As another example, the additional context may include additional prompt criteria defining a case summary, a description of relevant entities, and/or identifications of key documents (e.g., hot documents, or user input documents). As another example, the additional context may include instructions that cause the generative AI model to process different types of documents separately. For example, different data may be extracted from different documents, different meta data in different documents may be extracted and/or analyzed separately, etc. For example, a portable document format (PDF) may be processed using a multimodal model and/or may be used to generate a textual description of a PDF. As another example, the additional context may include a set of instructions that cause the generative AI model to expressly handle individual issues in a prompt (e.g., defined by the prompt criteria) based on the document type. Additionally, the types of documents in the corpus of documents may affect/influence how prompt criteria are updated.

At block 1206, the prompt evaluation application 124 evaluates classification performance of the prompt at classifying documents in the corpus of documents with respect to the relevancy requirement(s) defined by the prompt criteria. The classifications may be any suitable classifications. In some examples, a document may be classified as junk, responsive, not responsive, likely responsive, or not likely responsive. For example, the prompt evaluation application 124 may evaluate classification performance of the prompt with respect to the relevancy requirement by inputting the prompt and each document of a sample of documents from the corpus of documents into the generative AI model to obtain a set of respective classifications of the sample of documents, obtaining review data associated with the sample of documents including ground truth data associated with the relevancy requirement, and applying the review data to determine classification performance of the prompt with respect to the relevancy requirement.

At block 1208, the prompt generation application 123 obtains an updated prompt criteria including an updated description of the issue.

At block 1210, the prompt generation application 123 generates an updated prompt based upon the updated prompt criteria. In some examples, the prompt generation application 123 analyzes, via the generative AI model 125 (or another generative AI model, such as the second generative AI model 126), for example, the prompt criteria to determine that no contradiction exists between the relevancy requirement and the description of the issue, in response to determining that a contradiction exists, the prompt generation application 123 may generate an alert for a user (e.g., an alert for the first user 160). For example, a contradiction between the prompt criteria may be a conflicting set of instructions (e.g., do X in response to Y; and do Z in response to Y; where X and Z are mutually exclusive actions), a grammatical error, a lack of coherence in a set of instructions, etc.

At block 1212, the prompt evaluation application 124 evaluates classification performance of the updated prompt at classifying documents with respect to the relevancy requirement. For example, the prompt evaluation application 124 may compare the classification performance associated with the prompt to classification performance associated with the updated prompt. For example, the prompt evaluation application 124 may determine that classification performance of the updated prompt with respect to the issue has improved over the classification performance of the prompt with respect to the issue. As another example, the prompt evaluation application 124 may determine that classification performance of the updated prompt with respect to the relevancy requirement has not degraded over the classification performance of the prompt with respect to the relevancy requirement.

At block 1214, the prompt evaluation application 124, approves the updated prompt to classify additional documents in the corpus of documents based on the evaluation.

### Automated Prompting of an Example Generative AI Model

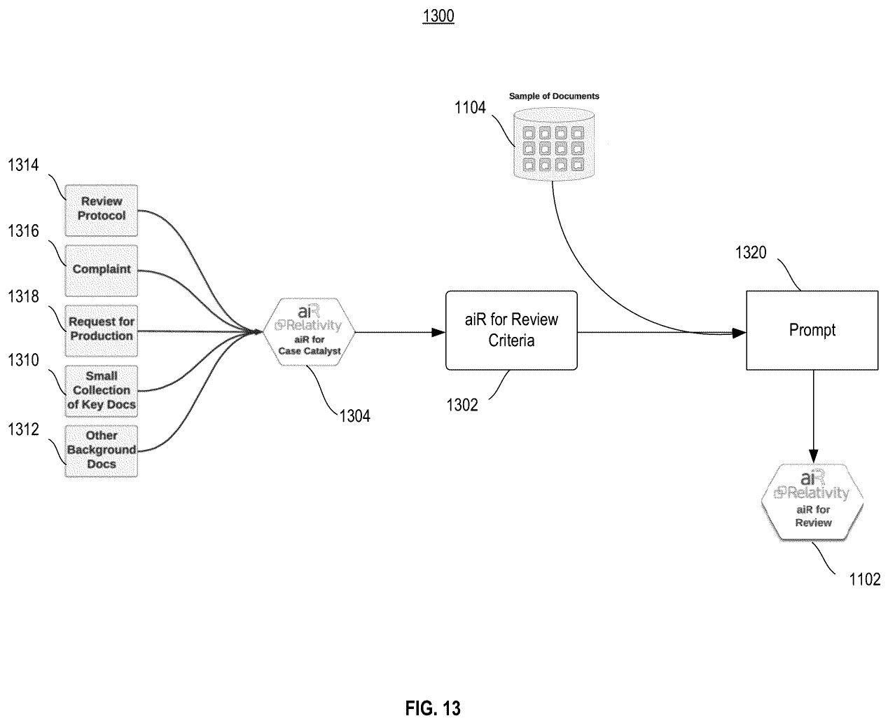

FIG. 13 depicts an automated prompting approach 1300 for the prompt-based classification model 1102 of FIG. 11 (e.g., the prompt-based classification model used in conjunction with the first generative AI model 125) for generating initial prompt criteria 1302 for input to the classification model 1102. More particularly, a generative AI model 1304 (e.g., the first generative AI model 125) may generate the initial prompt criteria 1302 based on an initial set of documents and/or contextual information associated with an inquiry (e.g., a request for production). Example techniques for selecting the initial set of documents are described in U.S. Provisional Application No. 63/72231 (Attorney Docket No. 32646/70317P), entitled “Systems and Methods for Identifying a Seed Set of Documents from a Corpus of Documents”, filed Nov. 19, 2024, the entire disclosure of which is hereby incorporated by reference.

The prompt generation application 123 may generate the initial prompt criteria 1302 by inputting the initial set of documents and the contextual information to the generative AI model 1304. In some embodiments, the initial set of documents includes one or more key documents 1310 and/or one or more background documents 1312. For example, the initial set of documents may include one or more communications from a user associated with a request for production (e.g., a key document 1310) and one or more contractual agreements associated with the user (e.g., a background document 1312). In some embodiments, the contextual information may include a review protocol 1314, one or more complaints 1316, and/or request for production information 1318. Additionally or alternatively, the prompt evaluation application 124 may input, with the initial set of documents and the contextual information, additional context to the generative AI model 1304 including a set of instructions that define how the initial set of documents and the contextual information should be analyzed by the generative AI model 1304.

As described herein, prompt criteria may include a set, or sets, of instructions that define how a document should be analyzed and/or classified by the classification model 1102 with respect to relevancy requirements and/or the descriptions of the issues (e.g., relevance criteria 420 and/or issue criteria 422). Generally, the one or more key documents 1310, the one or more background documents 1312, the review protocol 1314, the one or more complaints 1316, and/or the request for production information 1318, may be analyzed by the generative AI model 1304 to generate a set of instructions that define how a document should be analyzed by the classification model 1102.

Similar to the iterative prompting approach 1100 of FIG. 11, a sample of documents 1104 from a corpus of documents (e.g., the corpus of documents 105 of FIG. 1) may be evaluated using an initial prompt 1320 derived from the initial prompt criteria 1302 and input to the classification model 1102. Again, similar to the iterative prompting approach 1100, the classification model 1102 may output a classification of each input document (e.g., each document in the sample of documents 1104) in response to the input prompt. Based upon the classification output by the classification model 1102 and ground truth data associated with the sample of documents 1104, the prompt evaluation application 124 may generate classification performance reports for the initial prompt 1320. In some embodiments, the prompt evaluation application 124 automatically determines whether the initial prompt criteria 1302 needs to be updated. In other embodiments, prompt evaluation application 124 presents the performance reports to a user to receive a user-provided indication of whether the initial prompt criteria 1302 needs to be updated.

When the prompt evaluation application 124 determines that the prompt criteria 1302 does not need to be updated, the initial prompt criteria 1302 may be approved for classifying additional documents in the corpus of documents (e.g., documents from the corpus of documents 105 not included in the sample of documents 1104). On the other hand, when the prompt evaluation application 124 determines that the prompt criteria 1302 needs to be updated, the initial prompt criteria may be refined using the iterative prompting approach 1100, for example, or another prompting approach described herein.

### Example Methods

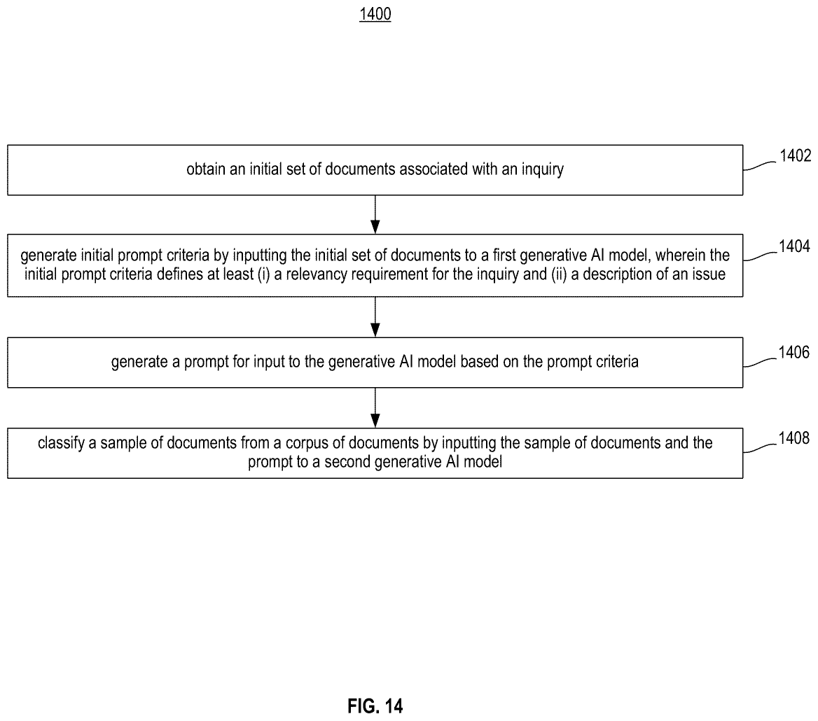

FIG. 14 illustrates a flow diagram representing an example computer-implemented method 1400 for using a generative artificial intelligence (AI) model to classify documents. The example method 1400 may be implemented by the computing environment 100 hosting the workspace 110. For example, the computing environment 100 may execute one or more of the applications 123, 124, 125, 126, 128, 130, 140, or 150 to perform functions described with respect to the method 1600.

The example method 1400 may begin at block 1402 when the document sampling application 130 obtains an initial set of documents associated with an inquiry. For example, the initial set of documents may include one or more of a complaint, a request for production, key documents, and/or one or more background documents.

At block 1404, the prompt generation application 123 generates initial prompt criteria by inputting the initial set of documents to a first generative AI model (e.g., the generative AI model 1304 of FIG. 13, the first generative AI model 125 of FIG. 1, or another similar generative AI model), wherein the initial prompt criteria defines at least (i) a relevancy requirement for the inquiry and (ii) a description of an issue. For example, generating the initial prompt criteria may include the prompt generation application 123 inputting an indication of a review protocol associated with the inquiry and the initial set of documents to the first generative AI model. In some embodiments, the relevancy requirement and the description of the issue are associated with respective component fields of the prompt criteria. Further, the prompt generation application 123 may generate one or more modified component fields corresponding to one or more component fields of the prompt criteria by inputting the prompt and the classification performance of the prompt to a third generative AI model. In some embodiments, at least one of the one or more modified component fields is associated with the relevancy requirement or the description of the issue. Additionally, the prompt generation application 123 may generate the modified prompt criteria based on the one or more modified component fields.

At block 1406, the prompt generation application 123 generates a prompt for input to the generative AI model based on the prompt criteria. In some embodiments, the prompt evaluation application 124 may analyze the prompt criteria and/or the prompt to determine that no contradiction exists between the relevancy requirement and the description of the issue. In response to determining that a contradiction exists, the prompt evaluation application 124 may generate an alert.

At block 1408, the prompt evaluation application 124 classifies a sample of documents from a corpus of documents (e.g., the corpus of documents 105 of FIG. 1) by inputting the sample of documents and the prompt to a second generative AI model (e.g., the prompt-based classification model 1102 of FIG. 11). In some embodiments, the prompt evaluation application 124 may evaluate classification performance of the modified prompt at classifying documents with respect to the relevancy requirement and the description of the issue. Further, based on the evaluation, the prompt evaluation application 124 may approve the modified prompt or the initial prompt to classify additional documents in the corpus of documents. For example, the prompt evaluation application 124 may compare the classification performance of the prompt to classification performance of the modified prompt.

In some embodiments, the example method 1400 may include one or more additional steps not depicted in FIG. 14. For example, the prompt evaluation application 124 may evaluate classification performance of the prompt based on ground truth data associated with the sample of documents. Continuing with this example, the prompt generation application 123 may obtain modified prompt criteria including one or more of (i) a modified relevancy requirement or (ii) a modified description of the issue, and may generate a modified prompt based on the modified prompt criteria. Further, the prompt evaluation application 124 may generate an updated classification of the sample of documents by inputting the sample of documents and the modified prompt to the second generative AI model. In some embodiments, the prompt evaluation application 124 may determine that classification performance of the modified prompt with respect to the issue has improved over the classification performance of the prompt with respect to the issue when evaluating classification performance of the modified prompt. In some embodiments, the prompt evaluation application 124 may determine that classification performance of the modified prompt with respect to the relevancy requirement has not degraded over the classification performance of the prompt with respect to the relevancy requirement.

### Automated Prompting of an Example Generative AI Model

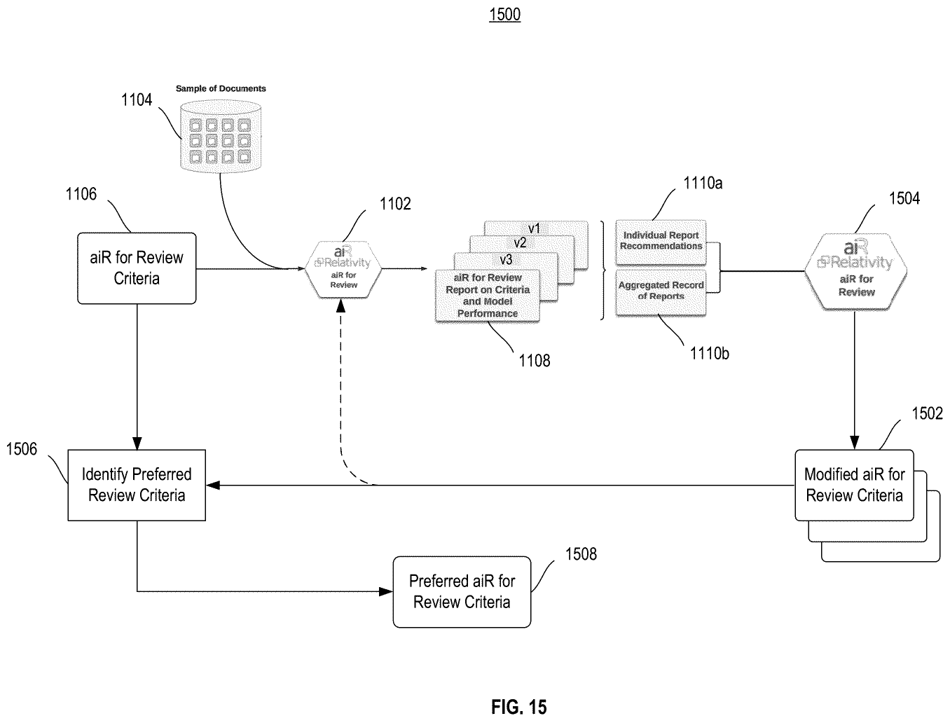

FIG. 15 depicts an automated prompting approach 1500 for the prompt-based classification model 1102 of FIG. 11 (e.g., the prompt-based classification model used in conjunction with the first generative AI model 125) for generating modified prompt criteria 1502 based on initial prompt criteria 1106. More particularly, a sample of documents 1104 from a corpus of documents (e.g., the corpus of documents 105 of FIG. 1) may be evaluated using a prompt derived from the initial prompt criteria 1106 that is input to the classification model 1102. Based on the classification performance of the initial prompt criteria 1106, a generative AI model 1504 (e.g., the first generative AI model 125) may generate the modified prompt criteria 1502.

In some embodiments, the prompt evaluation application 124 may generate classification performance reports and/or recommendations for the prompt criteria 1106 (e.g., performance reports 1108, individual report recommendations 1110a, and aggregated record of reports 1110b) based on the classifications output by the classification model 1102. For example, the prompt evaluation application 124 may generate classification performance reports by applying review data associated with the sample of documents 1104, and/or corresponding ground truth data, to the classifications output by the classification model 1102. In some embodiments, the classification performance reports generated by the prompt evaluation application 124 may include indications of misclassifications of the documents from the sample of documents 1104 and/or low-confidence classifications of the documents from the sample of documents 1104.

As described herein, prompt criteria may include a set, or sets, of instructions that define how a document should be analyzed and/or classified by the classification model 1102 with respect to relevancy requirements and/or descriptions of one or more issues associated with the corpus of documents. Said another way, the prompt criteria 1106 may include one or more component fields each corresponding to a relevancy requirement or a description of an issue. In some embodiments, the review data and the corresponding ground truth data may be associated with a relevancy requirement and/or a description of an issue defined by the prompt criteria 1106. Moreover, the classification performance reports may indicate the performance of the classification model 1102 at classifying documents in the sample of documents 1104 with respect to a particular component field of the prompt criteria 1106. For example, the classification performance reports may indicate that a component field of the prompt criteria 1106 and/or the modified prompt criteria 1502 is associated with a misclassification or low-confidence classification of one or more documents from the sample of documents 1104.

In some embodiments, the prompt generation application 123 may generate the modified prompt criteria 1502 by inputting the prompt derived from the initial prompt criteria 1106 and the classification performance reports/recommendations for the initial prompt criteria 1106 (e.g., performance reports 1108, individual report recommendations 1110a, and aggregated record of reports 1110b) to the generative AI model 1504. For example, the prompt generation application 123 may cause the generative AI model 1504 to generate a modified component field by modifying a component field of the initial prompt criteria 1106 that is associated with poor classification performance. In some embodiments, the prompt evaluation application 124 may input, with the prompt and the classification performance reports, additional context to the generative AI model 1504 including a set of instructions that define how the prompt and the classification performance reports should be analyzed by the generative AI model 1504.

In some embodiments, the prompt generation application 123 may generate, via the generative AI model 1504, one or more modified prompts derived from the modified prompt criteria 1502 including one or more modified component fields. For example, the prompt generation application 123 may generate two modified component fields of the prompt criteria 1106, each corresponding to poor classification performance, thereby producing at least three sets of prompt criteria (e.g., a first set including a first modified component field, a second set including a second modified component field, and a third set including both the first and the second modified component fields). As another example, based on the classification performance of a first set of modified prompt criteria 1502, the prompt evaluation application 124 may determine the prompt criteria needs to be modified further (e.g., based on a statistical performance metric, based on poor performance associated with an issue defined by the criteria, etc.) and the prompt generation application 123 may generate a second set of modified prompt criteria 1502. Moreover, the prompt generation application 123 may iteratively modify the initial prompt criteria 1106 using the generative AI model 1504 to produce multiple modified prompt criteria 1502.

At block 1506, based on the classification performance of the modified prompt criteria 1502 and the initial prompt criteria 1106, the prompt evaluation application 124 may select or identify preferred component fields from among the modified prompt criteria 1502 and the initial prompt criteria 1106 (e.g., a first component field from the initial prompt criteria 1106, a second component field from a first set of modified prompt criteria 1502, and a third component field from a second set of modified prompt criteria 1502) to generate preferred prompt criteria 1508. In some embodiments, the prompt evaluation application 124 and/or the review platform 140 may generate an indication of the preferred prompt criteria 1508 and provide the indication as an output of the review platform 140 (e.g., for review by the user 160). In response to identifying the preferred component fields, the prompt evaluation application 124 may approve the preferred prompt criteria 1508 and obtain classifications of additional documents in the corpus of documents (e.g., documents from the corps of documents 105 not included in the sample of documents 1104) using the preferred prompt criteria 1508.

### Example Methods

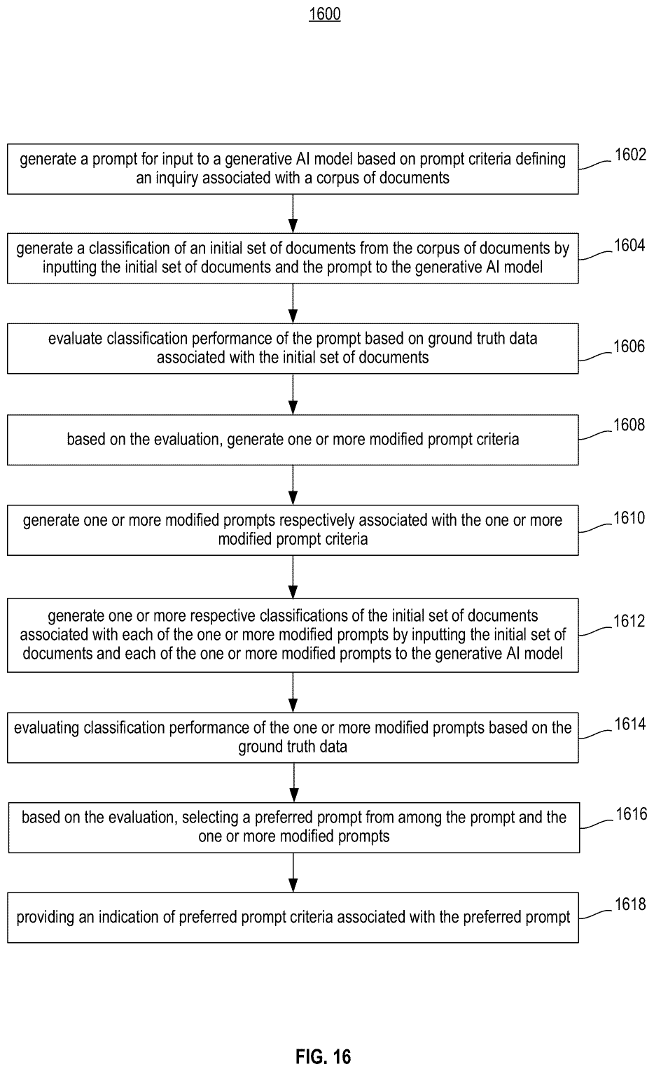

FIG. 16 illustrates a flow diagram representing an example computer-implemented method 1600 for using a generative artificial intelligence (AI) model to classify documents. The example method 1600 may be implemented by the computing environment 100 hosting the workspace 110. For example, the computing environment 100 may execute one or more of the applications 123, 124, 125, 126, 128, 130, 140, or 150 to perform functions described with respect to the method 1600.

The example method 1600 may begin at block 1602 when the prompt generation application 123 generates a prompt for input to the generative AI model based on prompt criteria defining an inquiry associated with a corpus of documents. In some embodiments, the prompt criteria include one or more component fields. For example, the prompt evaluation application 124 may evaluate classification performance of the one or more component fields of the prompt criteria based on the ground truth data. In some embodiments, the prompt generation application 123 may generate the prompt criteria by inputting one or more of: a review protocol, a complaint, a request for production, one or more of key documents, one or more background documents, to a generative AI model. In some embodiments, the prompt criteria defining the inquiry are initial prompt criteria. For example, the prompt generation application 123 may obtain a preliminary set of documents associated with the inquiry and the corpus of documents, wherein the preliminary set of documents include at least one of: (i) one or more key documents or (ii) one or more background documents, and generate the initial prompt criteria by inputting the preliminary set of documents to the generative AI model.

At block 1604, the prompt evaluation application 124 generates a classification of an initial set of documents from the corpus of documents by inputting the initial set of documents and the prompt to the generative AI model.

At block 1606, the prompt evaluation application 124 evaluates classification performance of the prompt based on ground truth data associated with the initial set of documents. In some embodiments, the classification performance of the prompt includes one or more of: one or more respective indications of one or more misclassifications of documents from the initial set of documents, and/or one or more respective indications of one or more low-confidence classifications of documents from the initial set of documents.

At block 1608, the prompt generation application 123 generates one or more modified prompt criteria based on the evaluation of the classification performance of the prompt. For example, the prompt generation application 123 may generate one or more modified component fields each corresponding to a component field of the one or more component fields by inputting the prompt and the classification performance of the one or more modified component fields to the generative AI model. Continuing with this example, the prompt generation application123 may generate the modified prompt criteria based on the one or more modified component fields. For example, the prompt generation application 123 may determine one or more component fields of the prompt criteria associated with at least one of the one or more misclassifications of documents and modify, by the generative AI model, the one or more component fields to generate the one or more modified component fields. As another example, the prompt generation application 123 may determine one or more component fields of the prompt criteria associated with at least one of the one or more low confidence classifications of documents and modify, by the generative AI model, the one or more component fields to generate the one or more modified component fields.

At block 1610, the prompt generation application 123 generates one or more modified prompts respectively associated with the one or more modified prompt criteria.

At block 1612, the prompt evaluation application 124 generates one or more respective classifications of the initial set of documents associated with each of the one or more modified prompts by inputting the initial set of documents and each of the one or more modified prompts to the generative AI model.

At block 1614, the prompt evaluation application 124 evaluates classification performance of the one or more modified prompts based on the ground truth data. For example, the prompt evaluation application 124 may evaluate classification performance of one or more respective component fields of each of the one or more modified prompt criteria based on the ground truth data.

At block 1616, the prompt evaluation application 124 selects a preferred prompt from among the prompt and the one or more modified prompts based on the evaluation of the classification performance of the one or more modified prompts. For example, the prompt evaluation application 124 may select, based on the evaluation, one or more first preferred component fields from among the one or more component fields of the prompt criteria and one or more second preferred component fields from among the one or more respective component fields of each of the one or more modified prompt criteria.

At block 1618, the review platform 140 provides an indication of preferred prompt criteria associated with the preferred prompt.

### Sampling of Documents for an Example Generative AI Model

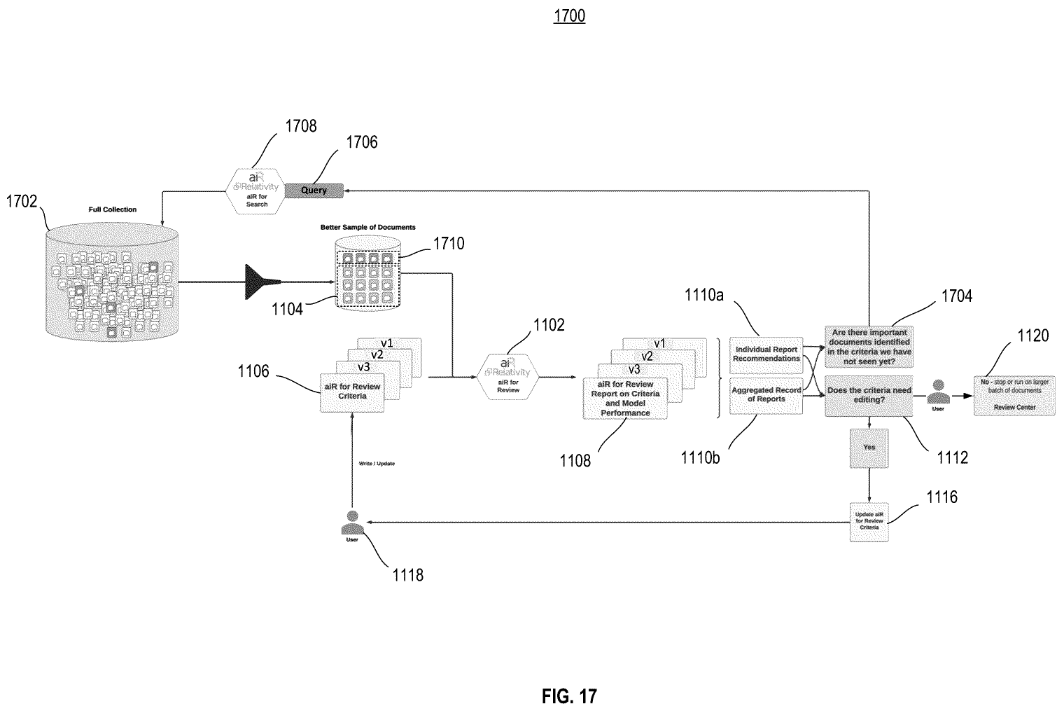

FIG. 17 depicts an iterative sampling approach 1700 for the prompt-based classification model 1102 of FIG. 11 (e.g., the prompt-based classification model used in conjunction with the first generative AI model 125) for refining samples of documents input to the classification model 1102. Generally, the classification model 1102, and moreover the iterative sampling approach 1700, may be implemented for responding to a request for production during litigation. Similar to the iterative prompting approach 1100 of FIG. 11, a sample of documents 1104, from a corpus of documents 1702 (e.g., the corpus of documents 105 of FIG. 1), may be processed using the classification model 1102. More particularly, the sample of documents 1104 may be evaluated using a prompt derived from the prompt criteria 1106 that is input to the classification model 1102. In response to the input prompt, the classification model 1102 may output a classification of each input document (e.g., each document in the sample of documents 1104).

Based upon the classifications output by the classification model 1102, the prompt evaluation application 124 may generate classification performance reports and/or recommendations for the prompt criteria 1106 (e.g., performance reports 1108, individual report recommendations 1110a, and aggregated record of reports 1110b). As mentioned above, the prompt criteria 1106 may include a set, or sets, of instructions that define how a document should be analyzed and/or classified by the classification model 1102 with respect to relevancy requirements and/or the descriptions of the issues. In some embodiments, the classification performance reports may indicate the performance of the classification model 1102 at classifying documents in the sample of documents 1104 with respect to the relevancy requirements and/or the descriptions of the issue defined by the prompt criteria 1106. In some embodiments, generating the classification performance reports/recommendations includes generating statistical metrics for each of the issues and/or relevancy requirements defined by the prompt criteria 1106. For example, the statistical metrics may include accuracy metrics, precision metrics, recall metrics, elusion metrics, and/or other classification metrics known in the art. In some embodiments, review data and/or corresponding ground truth data may be applied (e.g., to the sample of documents 1104 and/or to the associated classifications for the sample of documents 1104) to determine the classification performance of the prompt with respect to the issues and/or relevancy requirements defined by the prompt criteria 1106.

At block 1704, based on the performance reports 1108, the individual report recommendations 1110a, and the aggregated record of reports 1110b, the document sampling application 130 and/or the prompt evaluation application 124 may determine whether important documents (e.g., documents identified in the prompt criteria 1106), or types of important documents, have not been evaluated using the classification model 1102. In some embodiments, based on the outputs of the classification model 1102, the document sampling application 130 and/or the prompt evaluation application 124 may identify that the sample of documents 1104 does not include enough documents associated with a description of an issue defined by the prompt criteria 1106. For example, identifying that the sample of documents 1104 does not include enough documents associated with a description of an issue defined by the prompt criteria 1106 may include evaluating statistical metrics associated with an issue defined by the prompt criteria to identify statistical metrics that are statistically insignificant based on the amount of documents in the sample of documents 1104 associated with the issue. In some embodiments, based on the outputs of the classification model 1102, the document sampling application 130 and/or the prompt evaluation application 124 may identify that the corpus of documents 1702 is associated a new issue that is not defined by the prompt criteria 1106.

When the document sampling application 130 and/or the prompt evaluation application 124 determines that the sample of documents 1104 does not include a sufficient variety of documents, does not include enough documents of a particular type, and/or does not include particular documents, the document sampling application 130 may generate a query 1706 for the corpus of documents 1702. In some embodiments, the query 1706 may include indications (e.g., if query 1706 is a vector search, the indications may be vector embeddings/representations) of key terms associated with important documents or document types, a description of an issue defined by the prompt criteria 1106, and/or a new issue not defined by the prompt criteria 1106. For example, the key terms may be associated with an entity involved in a matter being litigated and the sample of documents 1104 may not include any documents associated with the entity. The document sampling application 130 may send the query 1706 to a search index 1708 for the corpus of documents 1702 and/or associated identifying information for the documents. For example, query 1706 may be a vector search and search index 1708 may be a vector database, and the search index 1708 may store vector embeddings and/or vector representations of the documents in the corpus of documents 1702. Based on the documents that are responsive to the query 1706, the document sampling application 130 and/or the search index 1708 may retrieve a set of additional documents 1710. It should be noted that the document sampling application 130 may generate any suitable request for documents from the corpus of documents (e.g., query 1706), such as a vector search, a database query, a keyword search, a Boolean search, etc., and the document sampling application 130 may send the request for documents to any suitable datastore, such as a vector database, a search engine, a structured query language (SQL) database, another relational database, etc.

In some embodiments, the corpus of documents 1702 may be associated with a vector space (e.g., the search index 1708 is a vector database) and the document sampling application 130 may evaluate the vector space to identify clusters of documents in the corpus of documents (e.g., groups of similar vector representations of the documents in the corpus of documents 1702). Further, the document sampling application 130 may evaluate the vector space to identify that one or more clusters of documents are associated with misclassifications and/or low-confidence classifications of documents from the sample of documents 1104 (e.g., identify clusters of documents that include at least one misclassified document). For example, the document sampling application 130 may evaluate the one or more identified clusters of documents to determine whether the sample of documents 1104 does not include enough documents from the identified clusters of documents to satisfy a confidence threshold. As another example, the document sampling application 130 may evaluate the one or more identified clusters of documents to determine that whether a cluster of documents is not associated with at least one issue defined by the prompt criteria 1106.

In some embodiments, the issues, the relevancy requirements, and/or the corpus of documents 1702 may be associated with a knowledge graph of facts (e.g., a structured representation/visualization of known facts and relationships between the facts). Further, the document sampling application 130 may evaluate the knowledge graph of facts to determine whether the sample of documents 1104 is sufficient. For example, the document sampling application 130 may evaluate the knowledge graph of facts and the prompt criteria 1106 to identify one or more new issues and/or one or more new relevancy requirements associated with the corpus of documents 1702. Continuing with this example, the document sampling application 130 may obtain additional documents from the corpus of documents 1702 associated with one or more new issues and/or one or more new relevancy requirements. As another example, the document sampling application 130 may identify that the sample of documents 1104 does not include enough documents associated with a particular issue (e.g., the sample of documents 1104 does not include a sufficient variety of documents, does not include enough documents of a particular type, and/or does not include particular documents) based on identifying one or more regions of the knowledge graph of facts associated with the particular issue and one or more misclassifications of documents in the sample of documents 1104.

Further, a second sample of documents including the additional documents 1710 and the sample of documents 1104 may be evaluated using a prompt (e.g., a prompt derived from the prompt criteria 1106, another version of the prompt criteria 1106, and/or other prompt criteria) that is input to the classification model 1102. The classifications for each document in the second sample of documents, and corresponding classification performance reports, output by the classification model 1102 may be processed by one or more of the applications 123, 124, 125, 126, 128, 130, 140, or 150 executing in the computing environment 100 to determine whether the second sample of documents is sufficient (e.g., sufficient for further evaluation of the prompt criteria 1106 and/or subsequent refinement of the prompt criteria 1106). In response, the functionality described with respect to blocks 1102-20 and blocks 1702-1710 may be repeated with respect to subsequent samples of documents from the corpus of documents 1702.

### Example Methods

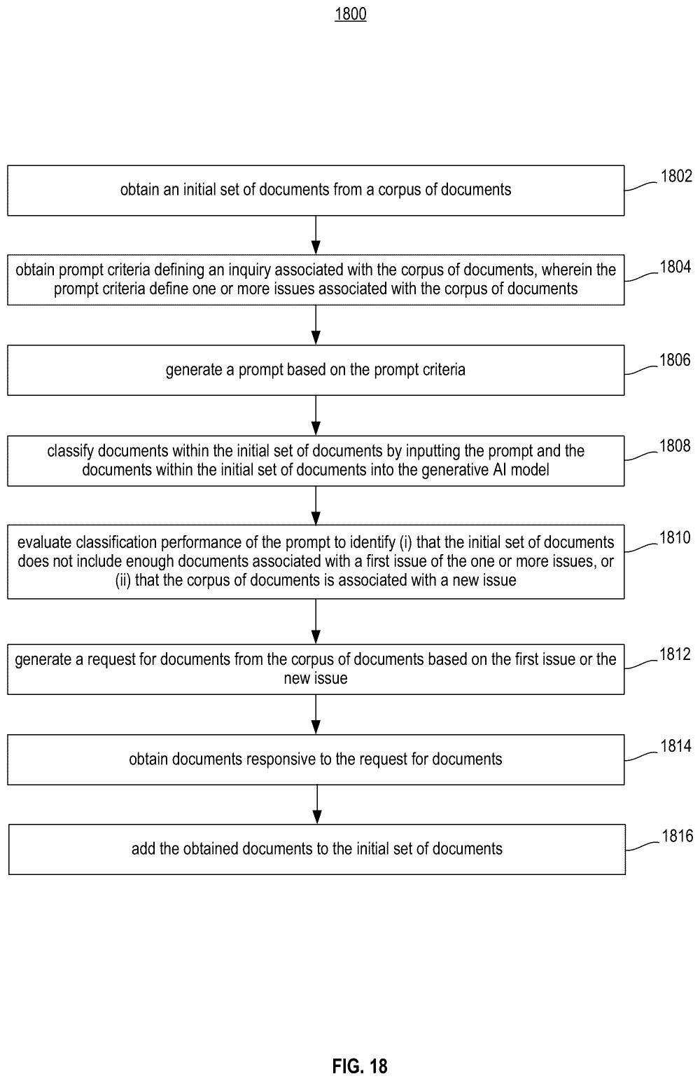

FIG. 18 illustrates a flow diagram representing an example computer-implemented method 1800 for using a generative artificial intelligence (AI) model to classify documents. The example method 1800 may be implemented by the computing environment 100 hosting the workspace 110. For example, the computing environment 100 may execute one or more of the applications 123, 124, 125, 126, 128, 130, 140, or 150 to perform functions described with respect to the method 1800.

The example method 1800 may begin at block 1802 when the document sampling application 130 obtains an initial set of documents from a corpus of documents. In some embodiments, the corpus of documents is associated with a vector space.

At block 1804, the prompt evaluation application 124 obtains prompt criteria defining an inquiry associated with the corpus of documents, wherein the prompt criteria define one or more issues associated with the corpus of documents. In some embodiments, the one or more issues are associated a knowledge graph of facts.

At block 1806, the prompt generation application 123 generates a prompt based on the prompt criteria.

At block 1808, the prompt evaluation application 124 classifies documents within the initial set of documents by inputting the prompt and the documents within the initial set of documents into the generative AI model.

At block 1810, the prompt evaluation application 124 evaluates classification performance of the prompt to identify (i) that the initial set of documents does not include enough documents associated with a first issue of the one or more issues, or (ii) that the corpus of documents is associated with a new issue. For example, the prompt evaluation application 124 may identify one or more respective clusters of documents in the vector space associated with one or more low-confidence classifications of documents of the initial set of documents. In some embodiments, the one or more low-confidence classifications of documents are one or more of: weak classifications of documents, or documents with no classifications. As another example, the prompt evaluation application 124 may evaluate the vector space associated with the corpus of documents to identify one or more clusters of documents. As yet another example, the prompt evaluation application 124 may identify one or more respective clusters of documents in the vector space associated with one or more misclassifications of documents of the initial set of documents. As still yet another example, the prompt evaluation application 124 may generate one or more respective statistical metrics for each of the one or more issues, wherein the one or more respective statistical metrics each include one or more of: an accuracy metric, a precision metric, a recall metrics, or an elusion metric. In some embodiments, the prompt evaluation application 124 may obtain review data associated with the initial set of documents including ground truth data associated the one or more issues and apply the review data to determine classification performance of the prompt with respect to the one or more issues.

In some embodiments, the prompt evaluation application 124 may evaluate the one or more respective clusters of documents associated with the one or more misclassifications of documents and the corpus of documents to identify that the initial set of documents does not include enough documents from the one or more respective clusters of documents, to identify that the initial set of documents does not include enough documents associated with the first issue of the one or more issues. For example, the prompt evaluation application 124 may generate one or more respective statistical metrics for each of the one or more issues, wherein the one or more respective statistical metrics each include one or more of: an accuracy metric, a precision metric, a recall metrics, or an elusion metric. Further, the prompt evaluation application 124 may evaluate one or more statistical metrics of the one or more respective statistical metrics associated with the first issue to identify that at least one statistical metric is statistically insignificant based on the amount of documents of the initial set of documents associated with the first issue. In some embodiments, the prompt evaluation application 124 may evaluate the one or more respective clusters of documents associated with the one or more misclassified documents and the prompt criteria to identify that at least one cluster of documents is not associated with at least one issue of the one or more issues, to identify that the corpus of documents is associated with the new issue. In some embodiments, the prompt evaluation application 124 may evaluate the knowledge graph of facts and the prompt criteria to identify the new issue. In some embodiments, the prompt evaluation application 124 may identify one or more regions of the knowledge graph of facts associated with one or more misclassifications of documents of the initial set of documents and the first issue of the one or more issues, to identify that the initial set of documents does not include enough documents associated with a first issue of the one or more issues.

At block 1812, the document sampling application 130 generates a request for documents from the corpus of documents based on the first issue or the new issue. For example, the document sampling application 130 may identify one or more key terms associated with (1) the first issue of the one or more issues or (2) the new issue associated with the corpus of documents and generate the request for documents based on the one or more key terms. In some embodiments, the one or more key terms may be associated with one or more entities.

At block 1814, the document sampling application 130 obtains documents responsive to the request for documents. In some embodiments, the prompt evaluation application 124 may classify the obtained documents responsive to the request for documents by inputting the prompt and the obtained documents into the generative AI model. In some embodiments, the prompt evaluation application 124 may evaluate classification performance of the prompt based on ground truth data associated with the obtained documents.

At block 1816, the document sampling application 130 adds the obtained documents to the initial set of documents.

### Training of an Example Classifier

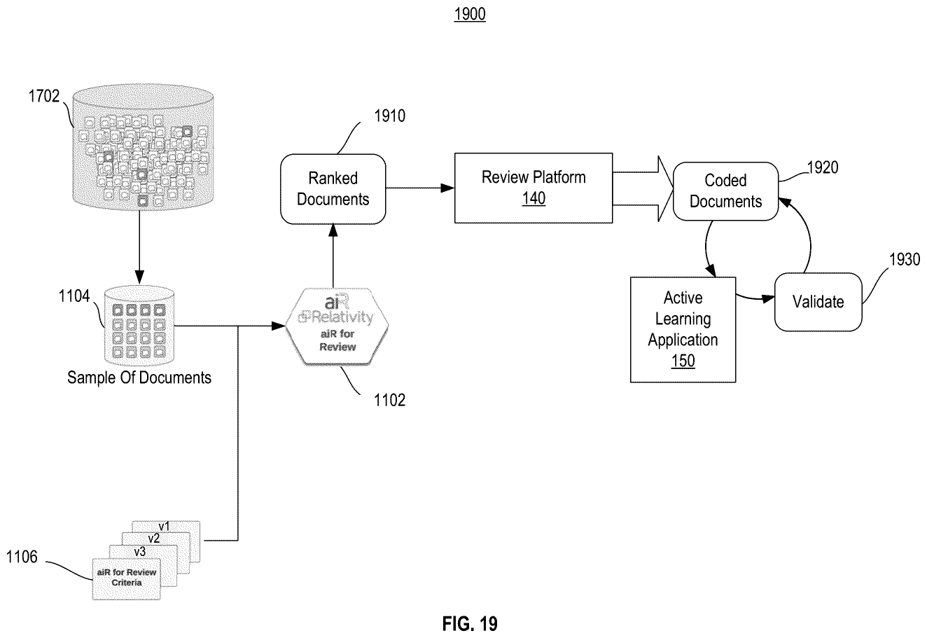

FIG. 19 depicts a training process 1900 for a machine learning classifier using the prompt-based classification model 1102 of FIG. 11 (e.g., the prompt-based classification model used in conjunction with the first generative AI model 125). Generally, the machine learning classifier, and moreover the training process 1900, may be implemented for responding to a request for production during litigation.

As described above, during an active learning process, documents from a corpus of documents 1702 (e.g., the corpus of documents 105 of FIG. 1) are manually reviewed by reviewers to provide ground truth data for training a classifier (e.g., a classifier trained via the active learning application 150 of FIG. 1). In some aspects, if the reviewers are provided particularly relevant documents and/or documents near the classifier hyperplane, the active learning process may be completed faster, as the classifier is trained using the documents that are most useful for discriminating between potential classes. However, without manual review, it may be difficult to identify these documents to improve the training speed of an active learning process. Thus, instant techniques relate to using a machine learning model (e.g., the classification model 1102) to classify documents within the corpus of documents such that the appropriate documents can be included in batches of documents reviewed by reviewers. As a result, the reviewers are more likely to review documents that assist in segmenting the classes, thereby reducing the number of documents that must be manually reviewed to train the active learning classifier. This saves both time and cost with respect to responding to a request for production.

As illustrated, to begin the process 1900, a sample of documents 1104, from the corpus of documents 1702 may be processed using the classification model 1102. More particularly, the sample of documents 1104 may be evaluated using a prompt derived from the prompt criteria 1106 that is input to the classification model 1102. In response to the input prompt, the classification model 1102 may output a classification of each input document (e.g., each input document in the sample of documents 1104). For example, the classification may include a responsiveness score related to the request for production. In these examples, the responsiveness score may be a score on a scale of 1-5 where 5 is highly relevant, 3 is borderline, and 1 is not relevant at all and corresponding instructions for performing the evaluation. Of course, in other examples, different classification scales may be implemented (e.g., a score on a scale of 1-10 or 1-100). Based on the responsiveness scores, the disclosed systems are able to identify the subset of the corpus of documents that are most likely to response (e.g., a 5) or borderline (e.g., a 3) such that batches presented to the reviewer are formed in manner that reduces training time for the active learning classifier.

In addition to instructions for performing the classification, the prompt input to the classification model 1102 may include a set of instructions that cause the classification model 1102 to generate additional context related to the classification decision. For example, the instruction may instruct the classification model 1102 to identify relevant document portions (e.g., citations, excerpts, etc.) in support of the classification decision. For example, the relevant document portions for a document may be the portions most indicative of responsiveness to an inquiry defined by the prompt criteria 1106. Moreover, the set of instructions included in the prompt, or the prompt criteria 1106, may guide and/or cause the classification model 1102 to reach intermediate conclusions and provide explanations for why the classification model 1102 generated a particular classification (e.g., as described with respect to FIG. 1 and FIG. 6) and/or why the classification may be incorrect. In some embodiments, the set of instructions may cause the classification model 1102 to extract relevant document portions from a document and as metadata associated with the document. The relevant document portions, as well as any other additional context generated by the classification model 1102, may be presented to the user via the review platform 140 to facilitate faster manual review of the document.

Based upon the classifications output by the classification model 1102 (block 1910), the review platform 140 may generate a priority ranking for documents input to the classification model 1102. For example, the classifications may include the responsiveness score, and/or other relevancy metrics/scores for the respective documents, and the review platform 140 may rank and/or sort documents based on respective scores. Generally, the review platform 140 may generate batches of the sample of documents 1104 based on one or more queues of documents. In the instant embodiments, a queue may be established corresponding to each classification to a reviewer based (e.g., based on the priority ranking and/or the respective scores for each document). Accordingly, the review platform 140 may select documents from the appropriate queues when generating batches of documents for reviewers. The review platform 140 may then present documents from the assigned batches to the reviewer to obtain review data for training the active learning classifier.

The review platform 140 may provide a set of coded documents 1920 (e.g., documents for which review data and/or ground truth data was provided by a reviewer) to the active learning application 150. Generally, the active learning application 150 may train a machine learning classifier to predict the responsiveness and/or relevance for documents in the corpus of documents 1702 (e.g., as described with respect to FIG. 1) based on the review data received via the review platform 140.

It should be appreciated in a typical active learning process, the review data is used in conjunction with the complete document to train the active learning classifier. However, documents often have information not related to the relevant inquiry. This may result in a classifier model increasing the weights of irrelevant features during the training process, potentially resulting in a larger number of training epochs needed to train the active learning classifier. To further reduce training time, techniques described herein may only associate the review data with the relevant portion of the document (and/or other additional context derived by the classification model). That is, when training the active learning classifier, only features derived from the relevant portions may influence the model weights. As a result, the use of the classification model 1102 to extract relevant portions of the document for training an active learning classifier may further reduce the amount of time it takes to train a classifier via an active learning process.

It should be appreciated that while the foregoing describes using the classifications provided by the classification model 1102 as ground truth data to train an active learning classifier, similar techniques may be applied to train other types of machine learning models. As one example, the classifications may be used to train or fine-tune a second generative AI model (such as the model 126). In this example, the second generative AI model may be a lightweight model that has a smaller feature space than the classification model 1102. Accordingly, the trained/tuned second model is able to perform inferences faster than the classification model 1102, which further speeds up the classification of the corpus of documents. As another example, the classifications generated by the classification model 1102 may be used to train other types of classification models, such a SVM classifier, a random forest classifier, or a gradient boosting machine (GBM) model, a regression model, etc., such that the trained model is able to classify documents faster than the classification model 1102.

### Example Methods

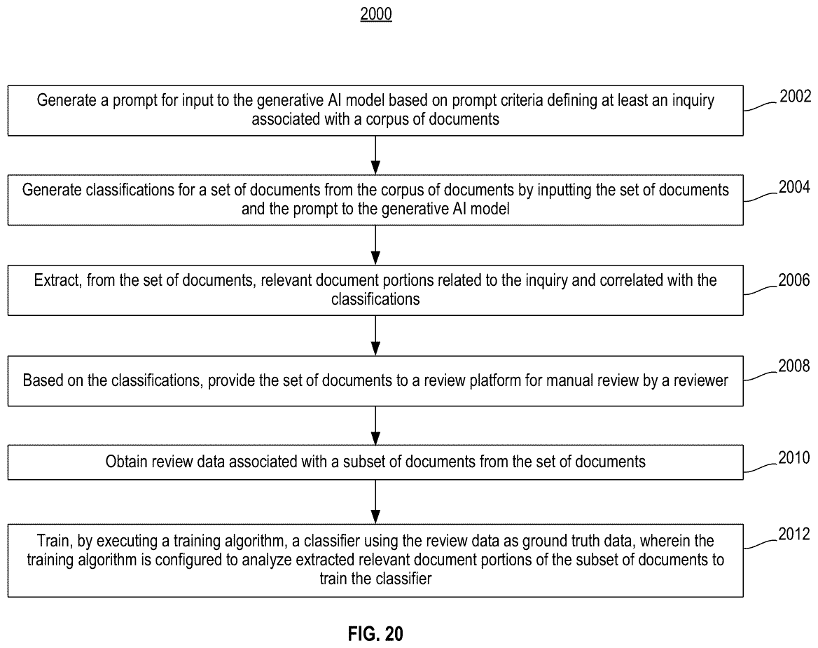

FIG. 20 illustrates a flow diagram representing an example computer-implemented method 2000 for using a generative artificial intelligence (AI) model to train a classifier. The example method 2000 may be implemented by the computing environment 100 hosting the workspace 110. For example, the computing environment 100 may execute one or more of the applications 123, 124, 125, 126, 128, 130, 140, or 150 to perform functions described with respect to the method 2000.

The example method 2000 may begin at block 2002 when the prompt generation application 123 generates a prompt for input to the generative AI model (e.g., the classification model 1102 of FIG. 11) based on prompt criteria defining at least an inquiry associated with a corpus of documents (e.g., the corpus of documents 105 of FIG. 1).

At block 2004, the prompt evaluation application 124 and/or the active learning application 150 may generate classification for a set of documents from the corpus of documents by inputting the set of documents and the prompt to the generative AI model. In some embodiments, the prompt and/or the prompt criteria may include one or more sets of instructions. For example, a set of instructions included in the prompt may cause the generative AI model to generate, based on outputs of the generative AI model, explanations of why the generative AI model generated the classifications for the set of documents. As another example, the prompt may include a set of instruction that cause the generative AI model to identify and/or extract the relevant document portions from documents. In some embodiments, the generated explanations include indications of the relevant document portions.

At block 2006, the generative AI model may extract, from the set of documents, relevant document portions related to the inquiry and correlated with the classifications. For example, generating the classification for the set of documents may include determining, via the generative AI model, one or more relevant document portions related to the inquiry for each document of the set of documents.

At block 2008, the prompt evaluation application 124 and/or the active learning application 150 may provide, based on the classifications, the set of documents to a review platform 140 for manual review by a reviewer. In some embodiments, the review platform 140 generates a priority ranking for the set of documents based on the classification. For example, the classifications may include responsiveness scores and the subset of documents may be associated with a particular responsiveness score. Further, the documents may be presented via the review platform 140 for manual review by a reviewer in an ordered configuration based on the priority ranking.

At block 2010, the review platform 140 may obtain review data associated with a subset of documents from the set of documents. For example, the method 2000 may further include presenting, the review platform and on a display, documents included in the subset of documents to a reviewer. In some embodiments, presenting the provided documents includes presenting, via review platform 140 and with the provided documents, additional context derived from the generative AI model for each document of the provided documents. For example, the additional context may include one or more of: generated explanations, the classifications for the set of documents, a summary of the classifications for the set of documents, classification considerations, the priority ranking, and/or the indications of the relevant document portions.

At block 2012, the active learning application 150 may train, by executing a training algorithm (e.g., as described with respect to FIG. 19), the classifier using the review data as ground truth data. In some embodiments, the training algorithm is configured to analyze extracted relevant document portions of the subset of documents to train the classifier.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for using a generative artificial intelligence (AI) model to classify documents, the method comprising:
obtaining, via one or more processors, an initial set of documents from a corpus of documents;
obtaining, via the one or more processors, prompt criteria defining an inquiry associated with the corpus of documents, wherein the prompt criteria define one or more issues associated with the corpus of documents;
generating, via the one or more processors, a prompt based on the prompt criteria;
classifying, via the one or more processors, documents within the initial set of documents by inputting the prompt and the documents within the initial set of documents into the generative AI model;
evaluating, via the one or more processors, classification performance of the prompt to identify (i) that the initial set of documents does not include enough documents associated with a first issue of the one or more issues, or (ii) that the corpus of documents is associated with a new issue;
generating, via the one or more processors, a request for documents from the corpus of documents based on the first issue or the new issue;
obtaining, via the one or more processors, documents responsive to the request for documents; and
adding, via the one or more processors, the obtained documents to the initial set of documents.

2. The computer-implemented method of claim 1, wherein the corpus of documents is associated with a vector space.

3. The computer-implemented method of claim 2, wherein generating the request for documents comprises:
identifying, via the one or more processors, one or more key terms associated with (1) the first issue of the one or more issues or (2) the new issue associated with the corpus of documents; and
generating, via the one or more processors, the request for documents based on the one or more key terms.

4. The computer-implemented method of claim 3, wherein the one or more key terms are associated with one or more entities.

5. The computer-implemented method of claim 2, wherein evaluating classification performance of the prompt comprises:
evaluating, via the one or more processors, the vector space to identify one or more clusters of documents.

6. The computer-implemented method of claim 5, wherein evaluating classification performance of the prompt further comprises:
identifying, via the one or more processors, one or more respective clusters of documents in the vector space associated with one or more misclassifications of documents of the initial set of documents.

7. The computer-implemented method of claim 6, wherein identifying that the initial set of documents does not include enough documents associated with the first issue of the one or more issues comprises:
evaluating, via the one or more processors, the one or more respective clusters of documents associated with the one or more misclassifications of documents and the corpus of documents to identify that the initial set of documents does not include enough documents from the one or more respective clusters of documents.

8. The computer-implemented method of claim 6, wherein identifying that the corpus of documents is associated with the new issue comprises:
evaluating, via the one or more processors, the one or more respective clusters of documents associated with the one or more misclassifications of documents and the prompt criteria to identify that at least one cluster of documents is not associated with at least one issue of the one or more issues.

9. The computer-implemented method of claim 5, wherein evaluating classification performance of the prompt further comprises:
identifying, via the one or more processors, one or more respective clusters of documents in the vector space associated with one or more low-confidence classifications of documents of the initial set of documents.

10. The computer-implemented method of claim 9, wherein the one or more low-confidence classifications of documents are one or more of: weak classifications of documents, or documents with no classifications.

11. The computer-implemented method of claim 1, wherein evaluating classification performance of the prompt includes:
generating, via the one or more processors, one or more respective statistical metrics for each of the one or more issues, wherein the one or more respective statistical metrics each include one or more of: an accuracy metric, a precision metric, a recall metrics, or an elusion metric.

12. The computer-implemented method of claim 11, wherein identifying that the initial set of documents does not include enough documents associated with the first issue of the one or more issues comprises:
evaluating, via the one or more processors, one or more statistical metrics of the one or more respective statistical metrics associated with the first issue to identify that at least one statistical metric is statistically insignificant based on the amount of documents of the initial set of documents associated with the first issue.

13. The computer-implemented method of claim 1, wherein evaluating classification performance of the prompt comprises:
obtaining, via the one or more processors, review data associated with the initial set of documents including ground truth data associated the one or more issues; and
applying, via the one or more processors, the review data to determine classification performance of the prompt with respect to the one or more issues.

14. The computer-implemented method of claim 1, further comprising:
classifying, via the one or more processors, the obtained documents responsive to the request for documents by inputting the prompt and the obtained documents into the generative AI model.

15. The computer-implemented method of claim 14, further comprising:
evaluating, via the one or more processors, classification performance of the prompt based on ground truth data associated with the obtained documents.

16. The computer-implemented method of claim 1, wherein the one or more issues are associated a knowledge graph of facts.

17. The computer-implemented method of claim 16, further comprising:
evaluating, via the one or more processors, the knowledge graph of facts and the prompt criteria to identify the new issue.

18. The computer-implemented method of claim 16, wherein identifying that the initial set of documents does not include enough documents associated with a first issue of the one or more issues comprises:
identifying, via the one or more processors, one or more regions of the knowledge graph of facts associated with one or more misclassifications of documents of the initial set of documents and the first issue of the one or more issues.

19. A computer system for using a generative artificial intelligence (AI) model to classify documents, the computer system comprising:
one or more processors; and
one or more non-transitory memories, the one or more non-transitory memories having stored thereon computer-executable instructions that, when executed by the one or more processors, cause the one or more processors to:
obtain an initial set of documents from a corpus of documents;
obtain prompt criteria defining an inquiry associated with the corpus of documents, wherein the prompt criteria define one or more issues associated with the corpus of documents;
generate a prompt based on the prompt criteria;
classify documents within the initial set of documents by inputting the prompt and the documents within the initial set of documents into the generative AI model;
evaluate classification performance of the prompt to identify (i) that the initial set of documents does not include enough documents associated with a first issue of the one or more issues, or (ii) that the corpus of documents is associated with a new issue;
generate a request for documents from the corpus of documents based on the first issue or the new issue;
obtain documents responsive to the request for documents; and
add the obtained documents to the initial set of documents.

20. A tangible, non-transitory computer readable medium storing computer-readable instructions that, when executed by one or more processors of a computer system, cause the computer system to:
obtain an initial set of documents from a corpus of documents;
obtain prompt criteria defining an inquiry associated with the corpus of documents, wherein the prompt criteria define one or more issues associated with the corpus of documents;
generate a prompt based on the prompt criteria;
classify documents within the initial set of documents by inputting the prompt and the documents within the initial set of documents into a generative artificial intelligence (AI) model;
evaluate classification performance of the prompt to identify (i) that the initial set of documents does not include enough documents associated with a first issue of the one or more issues, or (ii) that the corpus of documents is associated with a new issue;
generate a request for documents from the corpus of documents based on the first issue or the new issue;
obtain documents responsive to the request for documents; and
add the obtained documents to the initial set of documents.
